(19) United States
(12) Patent Application Publication
(10) Pub. No.: US 2011/0056296 A1
(43) Pub. Date: Mar. 10, 2011

(54) PHYSICAL QUANTITY SENSOR, MANUFACTURING METHOD OF PHYSICAL QUANTITY SENSOR, AND ELECTRONIC APPARATUS

(75) Inventor: Kei KANEMOTO, Suwa (JP)

(73) Assignee: SEIKO EPSON CORPORATION, Tokyo (JP)

(21) Appl. No.: 12/873,527

(22) Filed: Sep. 1, 2010

(30) Foreign Application Priority Data
Sep. 7, 2009 (JP) 2009-205598
Jul. 2, 2010 (JP) 2010-151837

(51) Int. Cl. G01P 15/125; H01B 13/34

(52) U.S. Cl. 73/514.32; 216/13

(57) ABSTRACT

A physical quantity sensor includes: a fixing part; an elastic deforming part; a movable weight part coupled to the fixing part via the elastic deforming part; a fixed arm part extended from the fixing part; and a movable arm part extended from the movable weight part and provided to face the fixed arm part via a gap, wherein the fixed arm part and the movable arm part are laminated structures containing insulating layers and conductor layers, the fixed arm part has a first side surface conductor film provided on a side surface of the fixed arm part and a first connecting electrode part using the conductor layer and electrically connected to the first side surface conductor film, and the movable arm part has a second side surface conductor film provided on aside surface opposed to the first side surface conductor film and a second connecting electrode part using the conductor layer and electrically connected to the second side surface conductor film.

### BACKGROUND

1. Technical Field

The present invention relates to a physical quantity sensor such as an MEMS sensor (Micro Electro Mechanical Sensor), for example, a manufacturing method of a physical quantity sensor, an electronic apparatus having a physical quantity sensor, etc.

2. Related Art

A capacitive MEMS sensor as a physical quantity sensor manufactured using a semiconductor manufacturing technology is disclosed in JP-A-7-301640, for example. For the MEMS sensor, a structure including silicon (Si) is generally used. The silicon is not an insulating material, and thus, the component part having continuous silicon is electrically conductive. Accordingly, for capacity detection, electric separation in some way is necessary.

If an SOI (silicon on insulator) substrate is used, it is easy to make the respective plural parts forming the structure electrically independent (for example, see JP-A-2007-150098). Further, there is a method of electrically separating the parts necessary to be insulated by forming trench isolation, for example, on a typical silicon substrate (for example, see JP-T-2002-510139).

However, in the MEMS sensor disclosed in JP-A-2007-150098, since the SOI substrate is expensive, there has been a problem that it is difficult to employ the substrate when the lower cost of the MEMS sensor is strongly desired. Further, in the MEMS sensor disclosed in JP-T-2002-510139, when the trench isolation is provided on the silicon substrate, the manufacturing process of the MEMS sensor may become complex.

### SUMMARY

An advantage of some aspects of the invention is to provide a physical quantity sensor (MEMS sensor) relatively easily using a typical semiconductor manufacturing technology and reduce the cost of the physical quantity sensor, for example.

A physical quantity sensor of an aspect of the invention has a fixing frame part, an elastic deforming part, a movable weight part coupled to the fixing frame part via the elastic deforming part with a cavity part formed around, at least one fixed electrode part having a fixed electrode fixed to the fixing frame part as one electrode of a capacitive device, and at least one movable electrode part having a movable electrode moving integrally with the movable weight part and provided to face the fixed electrode part as the other electrode of the capacitive device, and the fixed electrode part includes a first laminated structure formed to project from the fixing frame part and containing plural insulating layers laminated on a substrate, a first side surface conductor film as the fixed electrode formed on a side surface along the projection direction of the first laminated structure, and a first connecting electrode part electrically connected to the first side surface conductor film provided in the first laminated structure or on the first laminated structure, the movable electrode part includes a second laminated structure formed to project from the movable weight part and face the fixed electrode part and containing plural insulating layers laminated on the substrate, a second side surface conductor film as the movable electrode formed on a side surface along the projection direction of the second laminated structure and opposed to the first side surface conductor film as the fixed electrode, and a second connecting electrode part electrically connected to the second side surface conductor film provided in the second laminated structure or on the second laminated structure.

A physical quantity sensor of another aspect of the invention includes a fixing part, an elastic deforming part, a movable weight part coupled to the fixing part via the elastic deforming part, a fixed arm part extended from the fixing part, and a movable arm part extended from the movable weight part and provided to face the fixed arm part via a gap, the fixed arm part and the movable arm part are laminated structures containing insulating layers and conductor layers, the fixed arm part has a first side surface conductor film provided on a side surface of the fixed arm part and a first connecting electrode part using the conductor layer and electrically connected to the first side surface conductor film, and the movable arm part has a second side surface conductor film provided on a side surface opposed to the first side surface conductor film and a second connecting electrode part using the conductor layer and electrically connected to the second side surface conductor film.

The physical quantity sensor of the aspect of the invention is manufactured by processing a laminated structure formed on a substrate using a semiconductor manufacturing technology, for example. Further, the physical quantity sensor of the aspect of the invention has a fixing frame part (fixing part), a movable weight part supported by an elastic deforming part to be movable in a detection axis direction, a capacitive device (variable capacitance capacitor) for detecting a physical quantity (for example, acceleration) of a target of detection.

The capacitive device (variable capacitance capacitor) has a fixed electrode part (fixed arm part) fixed to the fixing frame part and a movable electrode part (movable arm part) provided to face the fixed electrode part and moving integrally with the movable weight part (at least one set of the fixed electrode part and the movable electrode part are provided). The movable electrode part is formed to project from the movable weight part. The movable electrode part has a first laminated structure (containing plural laminated insulating layers) formed by processing the laminated structure on the substrate, and a first side surface conductor film provided on a side surface along the projection direction (on a side surface at least facing the fixed electrode part) as a fixed electrode (for example, formed to cover the side surface), for example. Further, the movable electrode part has a second laminated structure (containing plural laminated insulating layers) formed by processing the laminated structure on the substrate, and a second side surface conductor film provided on a side surface along the projection direction (on a side surface at least facing the fixed electrode part) as a movable electrode (for example, formed to cover the side surface), for example. Note that the first side surface conductor film may also be referred to as “first side surface conductor” or “first side wall conductor”. Similarly, the second side surface conductor film may also be referred to as “second side surface conductor” or “second side wall conductor”.

On the side surfaces facing each other in the respective two insulating structures (the first laminated structure and the second laminated structure), the side surface conductor films (the first side surface conductor film and the second side surface conductor film) as capacitive electrodes are formed, and it may be impossible to secure a path for providing a direct-current bias or a path for taking out a detection signal between the capacitive electrodes only by those. Accordingly, in the aspect of the invention, a first connecting electrode part is provided in the first laminated structure or on the first laminated structure, and, similarly, a second connecting electrode part is provided in the second laminated structure or on the second laminated structure.

The first connecting electrode part is electrically connected to the first side surface conductor film as the fixed electrode. The first connecting electrode part may be formed by a conductor layer having a predetermined pattern formed in the first laminated structure or on the first laminated structure, for example. For example, electric conduction can be secured by bringing the side surface of the conductor layer into contact with a part of the first side surface conductor film as the fixed electrode. Further, for example, when the conductor layer is embedded in the first laminated structure, a first contact hole (may also be referred to as “via hole” or “through hole”) that exposes at least a part of the surface of the embedded conductor layer (first internal conductor) is formed, a contact conductor (first connecting conductor) covering the bottom surface and the inner wall surface of the first contact hole and joining to the first side surface conductor film is formed, and thereby, the electric connection between the conductor layer (first internal conductor) as the first connecting electrode part and the first side surface conductor film as the fixed electrode can be realized.

As described above, since the first connecting electrode part is electrically connected to the first side surface conductor film as the fixed electrode, a bias voltage may be provided to the first side surface conductor film as the fixed electrode via the first connecting electrode part. Further, when the fixed electrode is an output electrode of a detection signal, the detection signal may be taken out via the first connecting electrode part. The first laminated structure is an insulating structure, and accordingly, it is easy to provide the first connecting electrode part.

Similarly, the second connecting electrode part is electrically connected to the second side surface conductor film as the movable electrode. The second connecting electrode part may be formed by a conductor layer having a predetermined pattern formed in the second laminated structure or on the second laminated structure, for example. For example, electric conduction can be secured by bringing the side surface of the conductor layer into contact with a part of the second side surface conductor film as the movable electrode. Further, for example, when the conductor layer is embedded in the second laminated structure, a second contact hole (may also be referred to as “via hole” or “through hole”) that exposes at least a part of the surface of the embedded conductor layer (second internal conductor) is formed, a contact conductor (second connecting conductor) covering the bottom surface and the inner wall surface of the second contact hole and joining to the second side surface conductor film is formed, and thereby, the electric connection between the conductor layer (second internal conductor) as the second connecting electrode part and the second side surface conductor film as the movable electrode can be realized.

As described above, since the second connecting electrode part is electrically connected to the second side surface conductor film as the movable electrode, a bias voltage may be provided to the second side surface conductor film as the movable electrode via the second connecting electrode part. Further, when the movable electrode is an output electrode of a detection signal, the detection signal may be taken out via the second connecting electrode part. The second laminated structure is an insulating structure, and accordingly, it is easy to provide the second connecting electrode part.

According to the structure of the aspect of the invention, the capacitive electrodes (the fixed electrode and the movable electrode) of the capacitive device are formed by conductor films formed on the side surfaces of the insulating structure (insulating base). Since the insulating structure is a basic structure, the fixed electrode and the movable electrode are inherently and electrically insulated. Further, using the insulating structure, it is easy to provide plural wires electrically independently, and, even when other electrodes of connecting electrodes or the like (electrodes other than the capacitive electrodes) are provided, the electric independence between the respective electrodes may be secured. Therefore, unlike the silicon-based physical quantity sensor (MEMS sensor), a special technique is not necessary to electrically separate the respective different conductors or the manufacturing process does not become complex. Further, for example, since the structure may be manufactured using a general semiconductor manufacturing technology, it is not necessary to use an expensive special substrate such as an SOI substrate and the cost rise may be suppressed. Furthermore, for example, the gap between the capacitive electrodes (electrode distance) is determined by the patterning accuracy of the insulating layers forming the laminated structure, and, if the current microfabrication technology of semiconductors is used, the gap between the capacitive electrodes may be made sufficiently narrow. This is effective for higher sensitivity of the sensor and leads to reduction of chip area.

In the physical quantity sensor of another aspect of the invention, the first connecting electrode part is provided in or on the first laminated structure, and has a first connecting conductor layer with an end thereof reaching the side surface of the first laminated structure, and the side surface of the first connecting conductor layer is in contact with the first side surface conductor film as the fixed electrode, and the second connecting electrode part is provided in or on the second laminated structure, and has a second connecting conductor layer with an end thereof reaching the side surface of the second laminated structure, and the side surface of the second connecting conductor layer is in contact with the second side surface conductor film as the movable electrode.

Further, in another aspect of the invention, the first connecting electrode part and the second connecting electrode part are provided within the insulating layer.

In the aspect of the invention, for example, the first connecting electrode part is formed in the first laminated structure or on the first laminated structure and at least one end reaches the side surface of the first laminated structure, the side surface of the end is in contact with a part of the first side surface conductor film as the fixed electrode, and thereby, the electric connection between the first connecting electrode part and the first side surface conductor film (that is, connection by surface contact formed when the side surface of the conductor layer forming the first connecting electrode part is directly connected to the first side surface conductor film) is secured.

For example, when the laminated structure is formed on the substrate, a conductor pattern to be the first connecting electrode part is formed, the laminated structure is vertically processed and the first laminated structure is formed, the first side surface conductor film is formed on the side surface of the resulting first laminated structure (where the side surface of the conductor layer as the first connecting electrode part is exposed) by sputtering or the like, and thereby, the structure of the aspect of the invention can easily be formed.

Similarly, for example, the second connecting electrode part is formed in the second laminated structure or on the second laminated structure and at least one end reaches the side surface of the second laminated structure, the side surface of the end is in contact with a part of the second side surface conductor film as the movable electrode, and thereby, the electric connection between the second connecting electrode part and the second side surface conductor film (that is, connection by surface contact formed when the side surface of the conductor layer forming the second connecting electrode part is directly connected to the second side surface conductor film) is secured.

For example, when the laminated structure is formed on the substrate, a conductor pattern to be the second connecting electrode part is formed, the laminated structure is vertically processed and the second laminated structure is formed, the second side surface conductor film is formed on the side surface of the resulting second laminated structure (where the side surface of the conductor layer as the second connecting electrode part is exposed) by sputtering or the like, and thereby, the structure of the aspect of the invention can easily be formed. According to the structure, wiring of the fixed electrode part or the movable electrode part can be simplified.

In the physical quantity sensor of another aspect of the invention, the first connecting electrode part has a first internal conductor provided within the first laminated structure and a first connecting conductor covering the inner wall surface of the first laminated structure provided with the first contact hole formed to expose at least a part of the surface of the first internal conductor, covering the surface of the first internal conductor exposed to the first contact hole, and joining to the first side surface conductor film as the fixed electrode, and the second connecting electrode part has a second internal conductor provided within the second laminated structure and a second connecting conductor covering the inner wall surface of the second laminated structure provided with the second contact hole formed to expose at least a part of the surface of the second internal conductor, covering the surface of the second internal conductor exposed to the second contact hole, and joining to the first side surface conductor film as the fixed electrode.

Further, in another aspect of the invention, a contact hole is provided in the fixed arm part or the movable arm part, and the first connecting electrode part and the first side surface conductor film or the second connecting electrode part and the second side surface conductor film are connected via the contact hole.

In the aspect of the invention, “first internal conductor” as the first connecting electrode part is embedded in the first laminated structure, and the “first internal conductor” is electrically connected to the first side surface conductor film via “first connecting conductor”. The “first connecting conductor” is a contact conductor for securing electric connection between the first internal conductor as the first connecting electrode part and the first side surface conductor film, and, for example, covers the inner wall surface of the first laminated structure provided with the first contact hole (contact hole) formed to expose at least a part of the surface of the first internal conductor, covers the surface of the first internal conductor exposed to the first contact hole, and joins to the first side surface conductor film as the fixed electrode. That is, when the conductor layer (the first internal conductor) as the first connecting electrode part is embedded in the first laminated structure, the first contact hole (may also be referred to as “via hole” or “through hole”) that exposes at least a part of the surface of the embedded first internal conductor is formed, the contact conductor (first connecting conductor) covering the bottom surface (that is, on the surface where the first internal conductor is exposed) and the inner wall surface of the first contact hole and joining to the first side surface conductor film is formed, and thereby, the electric connection between the conductor layer (first internal conductor) as the first connecting electrode part and the first side surface conductor film as the fixed electrode can be realized.

As advantages of the connection structure, for example, connection between the respective parts (i.e., the first side surface conductor film, the first connecting conductor, the first internal conductor) may reliably be secured, the contact surfaces between the conductors may be taken broader, and the margins (margins of locations or the like) at manufacturing may be easily secured, and the proven semiconductor manufacturing process using contact holes etc. may be employed, and thus, stability in the manufacturing process is good.

Similarly, “second internal conductor” as the second connecting electrode part is embedded in the second laminated structure, and the “second internal conductor” is electrically connected to the second side surface conductor film via “second connecting conductor”. The “second connecting conductor” is a contact conductor for securing electric connection between the second internal conductor as the second connecting electrode part and the second side surface conductor film, and, for example, covers the inner wall surface of the second laminated structure provided with the second contact hole (contact hole) formed to expose at least a part of the surface of the second internal conductor, covers the surface of the second internal conductor exposed to the second contact hole, and joins to the second conductor film as the movable electrode. That is, when the conductor layer (the second internal conductor) as the second connecting electrode part is embedded in the second laminated structure, the second contact hole (may also be referred to as “via hole” or “through hole”) that exposes at least a part of the surface of the embedded second internal conductor is formed, the contact conductor (second connecting conductor) covering the bottom surface (that is, on the surface where the second internal conductor is exposed) and the inner wall surface of the second contact hole and joining to the second side surface conductor film is formed, and thereby, the electric connection between the conductor layer (second internal conductor) as the second connecting electrode part and the second side surface conductor film as the movable electrode can be realized.

As advantages of the connection structure, as described above, for example, connection between the respective parts (i.e., the second side surface conductor film, the second connecting conductor, the second internal conductor) may reliably be secured, the contact surfaces between the conductors may be taken broader, and the margins (margins of locations or the like) at manufacturing may be easily secured, and the proven semiconductor manufacturing process using contact holes etc. may be employed, and thus, stability in the manufacturing process is good.

In the physical quantity sensor of another aspect of the invention, an integrated circuit part is provided in the fixing part, and the first connecting electrode part and the second connecting electrode part are connected to the integrated circuit part.

One configuration of the integrated circuit part of the physical quantity sensor may include, for example, a detection circuit part, and the detection circuit part includes an amplification circuit, an analog calibration and A/D conversion circuit, a central processing circuit (CPU), and an interface circuit. Note that, not limited to the configuration, but, for example, the CPU may be replaced by a control logic and the A/D conversion circuit may be provided at the output stage of the amplification circuit provided in the detection circuit part. Further, the analog/digital conversion circuit, the central processing unit may be provided in another integrated circuit in some cases.

Such a detection circuit part is connected to the fixed electrode part (fixed arm part) and the movable electrode part of the physical quantity sensor. A pair of the movable electrode part (movable arm part) and the fixed electrode part forms a capacitor. The potential of one electrode of the capacitor is fixed to the reference potential (for example, ground potential). Here, the reference potential (for example, ground potential) is connected either the movable electrode part or the fixed electrode part.

When acceleration is acted on the physical quantity sensor to which the integrated circuit part is connected, the gaps between the respective electrodes of the pair of the movable electrode part and the fixed electrode part change to larger or smaller. Since the gap and the capacitance have an inverse relation, the capacitance value of the capacitor formed by the movable electrode part and the fixed electrode part changes to smaller or larger. Charge transfer occurs according to the changes of the capacitance value of the capacitor.

The detection circuit part has a charge amplifier (Q/V conversion circuit), for example, and the charge amplifier converts a minute current signal (charge signal) generated due to the charge transfer into a voltage signal by a sampling operation and an integration (amplification) operation. The voltage signal output from the charge amplifier, i.e., an acceleration detection signal detected by the physical quantity sensor is calibrated (for example, adjustment of phase and signal amplitude or the like) by the analog calibration and A/D conversion circuit unit, and then, converted from the analog signal to a digital signal and output.

The above described detection circuit part may be formed in the fixing part of the physical quantity sensor using a semiconductor process (CMOS process, for example). In this manner, the integrated circuit connected to the fixed electrode part and the movable electrode part is integrally formed in the fixing part of the physical quantity sensor, and that may contribute to downsizing of the physical quantity sensor and an electronic apparatus using the sensor.

In the physical quantity sensor of another aspect of the invention, one of the first connecting electrode part and the second connecting electrode part is grounded.

As described above, in the case of the configuration in which the physical quantity sensor includes the integrated circuit part (containing the detection circuit part), the detection circuit part contained in the integrated circuit part is connected to the fixed electrode part and the movable electrode part of the physical quantity sensor. A pair of the movable electrode part and the fixed electrode part forms a capacitor. The potential of one electrode of the capacitor is fixed to the reference potential (for example, ground potential). Here, the reference potential (for example, ground potential) is connected to either the movable electrode part or the fixed electrode part.

The basic configuration of the charge amplifier (Q/V conversion circuit) of the detection circuit part has a first switch and a second switch forming a switched capacitor of the input part with the variable capacity, an operation amplifier, a feedback capacity (integration capacity), a third switch for resetting the feedback capacity, a fourth switch for sampling the output voltage of the operation amplifier, and a holding capacity (see FIG. 5A).

To the ends of the capacitor (variable capacity) formed by the pair of the movable electrode part and the fixed electrode part, a predetermined voltage is applied, and charge is accumulated in the variable capacity. In the case where both ends of the variable capacity are at the ground potential from the state that the feedback capacity is reset (both ends are shorted), the charge accumulated in the variable capacity transfers and the amount of charge is conserved. Then, the output voltage of the operation amplifier is held by the holding capacity Ch and the held voltage is the output voltage of the charge amplifier.

Since the physical quantity sensor and the integrated circuit part have the above described circuit configuration, the capacitance value may be detected with high accuracy and a highly sensitive physical quantity sensor can effectively be provided.

An electronic apparatus according to another aspect of the invention includes a physical quantity sensor of the physical quantity sensors of the above described aspects of the invention.

Since the electronic apparatus of the aspect of the invention includes the physical quantity sensor of the above described aspect of the invention, a small electronic apparatus whose cost is reduced and functionality is advanced may be provided.

That is, since the physical quantity sensor may be manufactured using an existing semiconductor process without using an expensive and special material such as an SOI substrate, the lower cost of the electronic apparatus can be realized.

Further, using the semiconductor process, the micro gap between the capacitive electrodes of the movable electrode part and the fixed electrode part is formed and the physical quantity sensor that can detect slight capacitance change between the capacitive electrodes is provided, and thereby, electronic apparatus that can realize highly sensitive physical quantity detection with high functionality may effectively be provided.

Furthermore, a small physical quantity sensor may be formed by microfabrication using the semiconductor process or the integrated circuit part containing the detection circuit part is formed in the fixing part, and that contributes to downsizing of electronic apparatus including the physical quantity sensor.

A manufacturing method of a physical quantity sensor of one aspect of the invention includes forming a laminated structure containing plural insulating layers and at least one conductor layer and containing a first connecting electrode part for connecting to a fixed electrode of a capacitive device and a second connecting electrode part for connecting to a movable electrode of the capacitive device formed by patterning of the at least one conductor layer on a substrate, patterning and partitioning the laminated structure into a fixing frame part, an elastic deforming part, a movable weight part coupled to the fixing frame part via the elastic deforming part, a fixed electrode part fixed to the fixing frame part and containing at least one first laminated structure and a movable electrode part containing at least one second laminated structure moving integrally with the movable weight part and provided to face the fixed electrode part, forming a fixed electrode in the fixed electrode part and forming a movable electrode in the movable electrode part, and etching the substrate to separate the respective movable weight part and movable electrode part from the fixing frame part, when the fixed electrode is formed in the fixed electrode part, a first side surface conductor film as the fixed electrode is formed on a side surface along a projection direction of the first laminated structure formed to project from the fixing frame part and the first side surface conductor film as the fixed electrode is formed to be electrically connected to the first connecting electrode part, and, when the movable electrode part is formed in the movable electrode part, a second side surface conductor film as the movable electrode is formed on a side surface along a projection direction of the second laminated structure formed to project from the movable weight part and face the fixed electrode part and on the side surface opposite to the first side surface conductor film as the fixed electrode and the second side surface conductor film as the movable electrode is formed to be electrically connected to the second connecting electrode part.

Further, in one aspect of the invention, the method includes forming a laminated structure using an insulating layer and a conductor layer on a substrate, etching the laminated structure to form a fixing part, a movable weight part, an elastic deforming part coupling the fixing part and the movable weight part, a fixed arm part extending from the fixing part, and a movable arm part extending from the movable weight part, forming a first side surface conductor film on a side surface of the fixed arm part and forming a second side surface conductor film on a side surface of the movable arm part, connecting a first connecting electrode part formed using the conductor layer of the fixed arm part and the first side surface conductor film and connecting a second connecting electrode part formed using the conductor layer of the movable arm part and the second side surface conductor film, and etching the substrate to form gaps between the respective movable weight part, movable arm part, and elastic deforming part and the substrate.

In the manufacturing method of the aspect of the invention, first, for example, the laminated structure containing plural insulating layers and at least one conductor layer is formed on a substrate. In the laminated structure, for example, the first connecting electrode part and the second connecting electrode part having a predetermined pattern formed by patterning the at least one conductor layer are formed in advance.

Then, the laminated structure is patterned and partitioned into the fixing frame part (the fixing part), the elastic deforming part, the movable weight part, at least one fixed electrode part (the fixed arm part, the first laminated structure) and at least one movable electrode part (the movable arm part, the second laminated structure) (note that, in the condition, the substrate is not processed and the respective parts are connected via the substrate).

Then, the fixed electrode is formed in the fixed electrode part and the movable electrode is formed in the movable electrode part. That is, the forming step of the fixed electrode is the step of forming the first conductor film on the side surface of the first laminated structure (on the side surface at least opposed to the second laminated structure), for example. The first conductor film is formed to be connected to the first connecting electrode part. For example, when at least one end of the conductor layer (the first connecting conductor layer) forming the first connecting electrode part reaches the side surface of the first laminated structure, if the first side surface conductor film is formed to cover the side surface, as a result, the side surface of the conductor layer (the first connecting conductor layer) forming the first connecting electrode part naturally contacts the first side surface conductor film and, by the surface contact of the side surface, the electric conduction between the conductor layer (the first connecting conductor layer) and the first side surface conductor film is secured (note that this is an example).

The formation of the movable electrode is similar. That is, for example, the forming step of the movable electrode is the step of forming the second conductor film on the side surface of the second laminated structure (on the side surface at least opposed to the second laminated structure). The second conductor film is formed to be connected to the second connecting electrode part. For example, when at least one end of the conductor layer (the second connecting conductor layer) forming the second connecting electrode part reaches the side surface of the second laminated structure, if the second side surface conductor film is formed to cover the side surface, as a result, the side surface of the conductor layer (the second connecting conductor layer) forming the second connecting electrode part naturally contacts the second side surface conductor film and, by the surface contact of the side surface, the electric conduction between the conductor layer (the second connecting conductor layer) and the second side surface conductor film is secured (note that this is an example).

In the manufacturing method of a physical quantity sensor of one aspect of the invention, at the step of forming the fixed electrode in the fixed electrode part and forming the movable electrode in the movable electrode part, a conductor material is deposited on the first laminated structure and the second laminated structure, then, the unnecessary conductor material is removed by etch back, and thereby, the first side surface conductor film as the fixed electrode and the second side surface conductor film as the movable electrode are formed.

In the aspect of the invention, in order to form the first side surface conductor film and the second side surface conductor film, for example, the conductor material is deposited on the entire surface of the patterned laminated structure (including the first laminated structure and the second laminated structure) (for example, deposited by sputtering or CVD) and then, the deposited metal material is etched back. That is, the parts deposited on the first laminated structure and the second laminated structure (if groove parts are formed on the substrate and the conductor material is deposited in the bottom surface parts of the groove parts, including the deposited parts) are removed by etching. As a result, the conductor material films attached to the side surfaces of the first laminated structure and the second laminated structure remain and the conductor material films become the first side surface conductor film and the second side surface conductor film.

In the manufacturing method of a physical quantity sensor of one aspect of the invention, at the step of forming the fixed electrode in the fixed electrode part and forming the movable electrode in the movable electrode part, directional sputtering of a conductor material is executed on the first laminated structure and the second laminated structure, and thereby, the first side surface conductor film as the fixed electrode and the second side surface conductor film as the movable electrode are formed.

Further, in one aspect of the invention, the first side surface conductor film and the second side surface conductor film are formed by ionization PVD or long-throw sputtering.

In the aspect of the invention, when the first side surface conductor film and the second side surface conductor film are formed, the directional sputtering (may be referred to as directive sputtering) is used. The directional sputtering (directive sputtering) is a technology of aligning the directions of metal atoms flying out from the target by sputtering and forming metal layers and metal films by the aligned metal atoms, for example. As the directional sputtering (directive sputtering), an ionization PVD (Physical Vapor Deposition) method or a low-pressure long-throw sputtering method may be used. Using the directional sputtering (directive sputtering), the first side surface conductor film and the second side surface conductor film may respectively be deposited directly (that is, without etch back) on the side surfaces of the first laminated structure and the second laminated structure.

The ionization PVD can be used for deposition (formation of barrier metal or the like) having good coverage for the via holes at the high aspect ratio, for example, and has advantages that a deposition rate to some degree may be secured, film quality may be improved, deposition with less damage may be performed, and the like. The high directionality of the ionization PVD may be realized, for example, when the metal atoms sputtered from the target are ionized in plasma and their metal ions are accelerated within the sheath of the substrate surface and perpendicularly enter the substrate (here, the substrate on which the laminated structure is formed). To realize the high directionality, it is effective to generate a strong magnetic field only immediately above the target.

Further, the long-throw sputtering is a sputtering method of suppressing the influence of a reflection angle and the influence of collision with background atoms for improvement of directionality. Ion beam sputtering typically generates plasma of rare gas such as argon (Ar) or xenon (Xe), allows the plasma to collide with the target metal electrode, and deposits the flicked out atoms on the substrate placed on the opposite side. Since the sputtered atoms are isotropically scattered, if the distance between the target electrode and the substrate is small, the sputtered atoms are affected by the scattering angle and they enter the substrate at various angles. In order to prevent this, the distance between the target electrode and the substrate is purposely extended and the pressure is lowered, and thereby, the influence of the reflection angle and the influence of collision with background atoms can be prevented. The sputtering having directionality using the technique is the long-throw sputtering (LTS), and the step coverage is remarkably improved using the long-throw sputtering. Therefore, the first side surface conductor film and the second side surface conductor film may stably be deposited on the side surfaces (for example, perpendicular surfaces) of the first laminated structure and the second laminated structure. Note that the above example is an example, but another directional (directive) sputtering method may be used.

In the manufacturing method of a physical quantity sensor of one aspect of the invention, at the step of forming the fixed electrode in the fixed electrode part and forming the movable electrode in the movable electrode part, a first contact hole is formed in the first laminated structure and a second contact hole is formed in the second laminated structure, and thereby, at least a part of the surface of the first internal conductor as the connecting electrode part for the fixed electrode and at least a part of the surface of the second internal conductor as the connecting electrode part for the movable electrode are exposed, a conductor material is deposited on the first laminated structure in which the first contact hole is formed and the second laminated structure in which the second contact hole is formed, and thereby, the first side surface conductor film as the fixed electrode, the first connecting conductor covering the inner wall surface of the first laminated structure provided with the first contact hole to expose the at least the part of the surface of the first internal conductor, covering the surface of the first internal conductor exposed to the first contact hole, and joining to the first side surface conductor film as the fixed electrode, the second side surface conductor film as the movable electrode, and the second connecting conductor covering the inner wall surface of the second laminated structure with the second contact hole formed to expose the at least the part of the surface of the second internal conductor, covering the surface of the second internal conductor exposed to the second contact hole, and joining to the second side surface conductor film as the movable electrode are formed.

Further, in another aspect of the invention, the method includes forming the first connecting electrode part and the second connecting electrode part within the insulating layer and forming a contact hole to expose at least a part of surfaces of the first connecting electrode part and the second connecting electrode part, and forming electrodes on an inner wall surface of the contact hole, a surface of the fixed arm part, and a surface of the movable arm part and connecting the first connecting electrode part and the first side surface conductor film and connecting the second connecting electrode part and the second side surface conductor film.

In the manufacturing method of the aspect of the invention, when the fixed electrode is formed in the fixed electrode part (fixed arm part) and the movable electrode part is formed in the movable electrode part (movable arm part), the method of securing electric conduction by forming contact is employed.

That is, the conductor layer (the first internal conductor) as the first connecting electrode part is embedded in the first laminated structure, the first contact hole (may also be referred to as “via hole” or “through hole”) that exposes at least a part of the surface of the embedded first internal conductor is formed, the contact conductor (first connecting conductor) covering the bottom surface (that is, on the surface where the first internal conductor is exposed) and the inner wall surface of the first contact hole and joining to the first side surface conductor film is formed by sputtering or the like, and, at the same time, the first side surface conductor film as the fixed electrode is formed.

Similarly, the conductor layer (the second internal conductor) as the second connecting electrode part is embedded in the second laminated structure, the second contact hole (may also be referred to as “via hole” or “through hole”) that exposes at least a part of the surface of the embedded second internal conductor is formed, the contact conductor (second connecting conductor) covering the bottom surface (that is, on the surface where the second internal conductor is exposed) and the inner wall surface of the second contact hole and joining to the second side surface conductor film is formed by sputtering, CVD, or the like, and, at the same time, the second side surface conductor film as the movable electrode is formed.

By employing the method, as described above, for example, connection between the respective parts (i.e., the side surface conductor film, the connecting conductor, the internal conductor) may reliably be secured, the contact surfaces between the conductors may be taken broader, and the margins (margins of locations or the like) at manufacturing may be easily secured, and the proven semiconductor manufacturing process using contact holes etc. may be employed, and thus, an advantage of stability in the manufacturing process can be obtained.

Note that, as specific manufacturing methods for “at the step of forming the fixed electrode in the fixed electrode part and forming the movable electrode in the movable electrode part, forming the first contact hole in the first laminated structure and forming the second contact hole in the second laminated structure”, there are two methods. That is, the first method is to form the first contact hole and the second contact hole at a predetermined distance in the common laminated structure before partitioning the laminated structure on the substrate into the first laminated structure and the second laminated structure, and then, selectively removing the parts between the first contact hole and the second contact hole of the common laminated structure and partitioning the laminated structure into the first laminated structure and the second laminated structure. According to the method, since the contact holes are formed in the common laminated structure before many comb-teeth structures are formed, there is an advantage that the contact holes are easily formed with high accuracy. Note that, in place of the first method, the second method in which the order of the contact hole formation and comb-teeth structure formation is reversed may be employed. That is, in the second method, the laminated structure is processed into the first laminated structure and the second laminated structure (that is, the comb-teeth structures are formed), and then, in the respective comb-teeth structures (that is, the respective first laminated structure and second laminated structure), the respective first contact hole and second contact hole are formed. If either method is employed, the obtained structure is the same. That is, if either method is employed, consequently, “the structure in which the first contact hole is formed in the first laminated structure and the second contact hole is formed in the second laminated structure” is obtained.

A manufacturing method of a physical quantity sensor of another aspect of the invention includes forming a laminated structure containing plural insulating layers and at least one conductor layer and containing a first connecting electrode part for connecting to a fixed electrode of a capacitive device and a second connecting electrode part for connecting to a movable electrode of the capacitive device formed by patterning of the at least one conductor layer on a substrate, patterning only a region of the laminated structure where the capacitive device is formed to provide at least one opening part, forming a conductor film covering an inner wall surface of the laminated structure provided with the at least one opening part, and patterning and partitioning the laminated structure in which the conductor film is formed into a fixing frame part, an elastic deforming part, a movable weight part coupled to the fixing frame part via the elastic deforming part, a fixed electrode part fixed to the fixing frame part and containing at least one first laminated structure, and a movable electrode part moving integrally with the movable weight part and containing at least one second laminated structure provided to face the fixed electrode part and forming the fixed electrode and the movable electrode as a result of the patterning of the conductor film covering the inner wall surface of the opening part, and etching the substrate to separate the respective movable weight part and movable electrode part from the fixing frame part.

In the manufacturing method of the aspect of the invention, the patterning of the laminated structure on the substrate is performed in twice. At the first patterning, the region where the capacitive devices is formed (i.e., capacitive device formation region including regions where opposed electrodes are formed) is selectively opened. Then, the conductor film covering the inner wall surface of the opening part is formed. For the formation of the conductor film, a method of a combination of sputtering and etch back, the directional (directive) sputtering method, or the like may be used. The conductor film will be the first side surface conductor film as the fixed electrode or the second side surface conductor film as the movable electrode later, however, under the condition, the film is deposited on all of the inner wall surfaces (inner circumferential surfaces) of the opening part, and contains unnecessary parts that do not function as a capacitive electrodes.

Then, the second patterning is executed, and thereby, the structure is partitioned into the fixing frame part, the elastic deforming part, the movable weight part, the fixed electrode part, and the movable electrode part. At the same time, the unnecessary conductor film parts that do not function as capacitive electrodes are removed, and the first side surface conductor film as the fixed electrode and the second side surface conductor film as the movable electrode are formed. For example, then, the etchant for isotropic etching is allowed to reach the substrate via the opening part and the substrate is isotropically etched, and thereby, the movable weight part and the movable electrode part are separated from the fixing frame part. The method of the aspect of the invention is effective as a variation (modified example) of the manufacturing process, for example.

### BRIEF DESCRIPTION OF THE DRAWINGS

The invention will be described with reference to the accompanying drawings, wherein like numbers reference like elements.

FIG. 1 is a plan view showing a configuration of an MEMS sensor as an example of a physical quantity sensor (here, a capacitive acceleration sensor) of an aspect of the invention.

FIG. 2 is a plan view of a main part of a capacitive device part and a sectional view along I-I line.

FIGS. 3A to 3F are diagrams (sectional views of a device) for explanation of an outline of a basic manufacturing process (first example) of a capacitive acceleration sensor shown in FIGS. 1 and 2.

FIG. 4 shows a configuration example of an integrated circuit part (containing a detection circuit part) of the capacitive acceleration sensor.

FIG. 5A to 5C are diagrams for explanation of an example of a configuration and an operation of a Q/V conversion circuit.

FIG. 6 shows a planar shape and a sectional structure of a device in a state in which a laminated structure is formed on a substrate (first step in the second embodiment).

FIG. 7 shows a planar shape and a sectional structure of the device in a state in which the laminated structure on the substrate is patterned (second step in the second embodiment).

FIG. 8 shows a planar shape and a sectional structure of the device in a state in which the substrate is etched and a movable weight part and a movable electrode part are separated from a fixing part (third step in the second embodiment).

FIG. 9 shows a planar shape and a sectional structure of the device in a state in which a metal material is deposited on the entire surface of the device (fourth step in the second embodiment).

FIG. 10 shows a planar shape and a sectional structure of the device in a state in which the metal film formed on the entire surface of the device is etched back (fifth step in the second embodiment).

FIG. 11 shows a planar shape and a sectional structure of the device in a state in which an etching mask (resist) is selectively formed in capacitive parts (comb-teeth electrode parts) (sixth step in the second embodiment).

FIG. 12 shows a planar shape and a sectional structure of the device in a state in which etching is entirely performed using the resist as the etching mask and then the resist is removed (seventh step in the second embodiment).

FIG. 13 is a plan view and a sectional view of a device for explanation of a manufacturing method using directional sputtering for formation of capacitive electrodes (the third embodiment).

FIG. 14 is a plan view of the device after the first patterning of the laminated structure in the fourth embodiment.

FIG. 15 is a plan view of the device showing a state in which metals are deposited on the inner wall surfaces of the laminated structure in which the opening parts have been formed in the fourth embodiment.

FIG. 16 is a plan view of the device showing a state in which a resist is patterned in the fourth embodiment.

FIG. 17 is a plan view of the device showing a state in which insulating films and metal films forming the laminated structure are etched using the resist pattern as an etching mask in the fourth embodiment.

FIG. 18 is a plan view showing a state in which the resist pattern as the etching mask is removed in the fourth embodiment.

FIGS. 19A and 19B are sectional views of a device at the first step and the second step for explanation of an outline of a manufacturing method (second example) of the capacitive acceleration sensor shown in FIGS. 1 and 2.

FIGS. 20A to 20C are sectional views of the device at the third step to the fifth step for explanation of the outline of the manufacturing method (second example) of the capacitive acceleration sensor.

FIGS. 21A to 21C are sectional views of the device at the sixth step to the eighth step for explanation of the outline of the manufacturing method (second example) of the capacitive acceleration sensor.

### DESCRIPTION OF EXEMPLARY EMBODIMENTS

Hereinafter, preferred embodiments of the invention will be described in detail. The embodiments explained as below do not unduly limit the subject matter of the invention described in claims, but all of the configurations explained in the embodiments are not necessarily essential as solution of the invention.

### First Embodiment

First, one configuration example of an MEMS sensor as a physical quantity sensor will be explained.

### Overall Configuration of Capacitive Acceleration Sensor

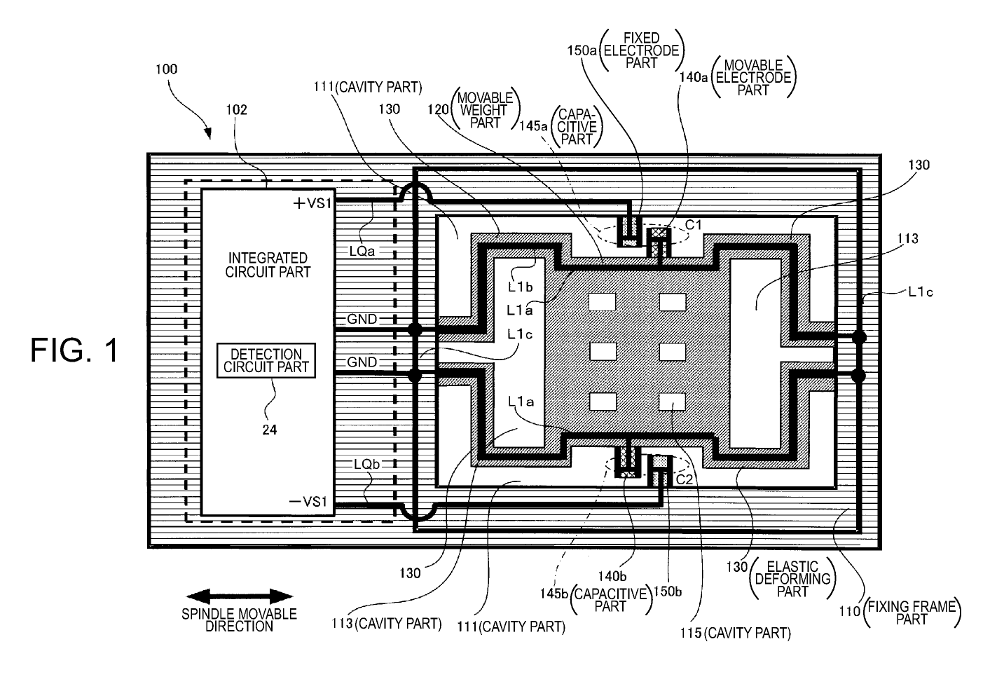

FIG. 1 is a plan view showing a configuration of an example of the MEMS sensor as a physical quantity sensor (here, a capacitive acceleration sensor) of an aspect of the invention. In the drawing, wires and electrodes formed by conducting materials are shown by thick solid lines.

In FIG. 1, a capacitive acceleration sensor 100 may be manufactured by forming a laminated structure on a substrate and selectively processing the laminated structure and the substrate using a semiconductor manufacturing technology. For example, after the laminated structure is formed on the substrate, the laminated structure is selectively patterned using anisotropic dry etching, for example, to form cavity parts 111, 113, 115, and further, an etchant for isotropic etching is allowed to reach the substrate surface via the cavity parts 111, 113, 115 for isotropic etching of the substrate. Thereby, the structure of the capacitive acceleration sensor 100 in FIG. 1 can be obtained.

The capacitive acceleration sensor 100 shown in FIG. 1 has a fixing frame part 110 as a fixing part (for example, a silicon substrate), an elastic deforming part (spring part) 130, a movable weight part 120 coupled to the fixing frame part 110 via the elastic deforming part 130 with the cavity parts 111 and 113 formed around, at least one fixed electrode part (fixed arm part) 150 fixed to the fixing frame part 110 and forming one electrode part of a capacitive part 145 (including a capacitive device C1 or a capacitive device C2), and at least one movable electrode part (movable arm part) 140 moving integrally with the movable weight part 120 and forming the other electrode part of the capacitive part 145 (the capacitive device C1 and the capacitive device C2) provided to face the fixed electrode part 150. Note that, in the embodiment, the example using the frame-shaped fixing frame part 110 as the fixing part of the capacitive acceleration sensor 100 is explained, however, the form of the fixing part is not limited to the frame shape, but, for example, a fixing part having a rectangular shape, an L-shape formed by a combination of rectangles, or a shape including an arc may be used.

Further, as the capacitive part 145, two capacitive parts 145a, 145b that output detection signals having the same absolute value but different polarities are provided. Accordingly, the direction in which acceleration is applied can be detected based on the polarities of the signals obtained from the two capacitive parts. The capacitive part 145a has a fixed electrode part 150a and a movable electrode part 140a provided to face each other. The fixed electrode part 150a and the movable electrode part 140a form the capacitive device C1. Similarly, the capacitive part 145b has a fixed electrode part 150b and a movable electrode part 140b provided to face each other. The fixed electrode part 150b and the movable electrode part 140b form the capacitive device C2.

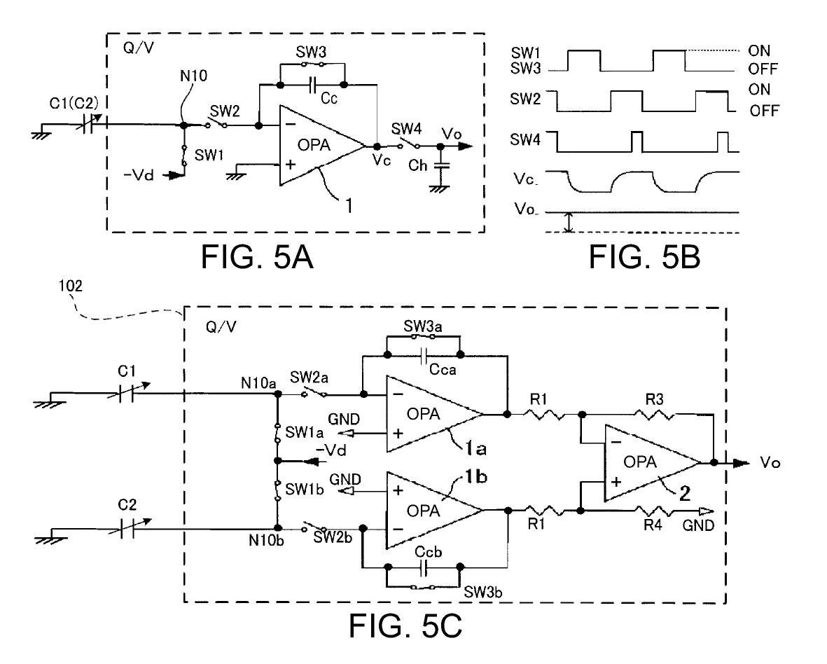

In the example of FIG. 1, the movable electrode of the movable electrode part 140 is connected to a reference potential (here, GND), a predetermined potential (≠GND) is applied to the fixed electrode in the fixed electrode part 150, and the fixed electrode serves as an output electrode of the detection signal. Note that this is an example, and the fixed electrode may be connected to the GND and the movable electrode may serve as an output electrode of the detection signal. The potential difference between the movable electrode and the fixed electrode is Vd, for example (see FIGS. 5A and 5C). Further, in FIG. 1, as GND wires (may be referred to as “common wires”), a first wire L1a (a wire provided within the movable weight part 120), a second wire L1b (a wire provided along the elastic deforming part 130), a third wire L1c (a wire provided on the fixing frame part 110) are provided.

Further, detection signal wires (signal output wires) LQa, LQb are provided for transmitting the detection signals (+VS1 and −VS1) output from the fixed electrode part 150 (150a, 150b) to (a detection circuit part 24 of) an integrated circuit part 102.

Furthermore, adjacent to the sensor part, the integrated circuit part 102 (having the detection circuit part 24) is provided. The integrated circuit part 102 is a circuit formed by a CMOS process, for example. This circuit may contain the detection circuit part 24, and the detection circuit part may include a Q/V conversion circuit (charge/voltage conversion circuit) and a differential amplification circuit, and further contain an analog calibration circuit, A/D converter, a CPU (signal processing circuit), or the like. The sensor part and the integrated circuit part 102 may be formed simultaneously in parallel using a common semiconductor manufacturing process technology.

The movable electrode part 140 is formed integrally with the movable weight part 120, and, when the movable weight part 120 is subjected to a force by acceleration and vibrates, similarly vibrates (in FIG. 1, the directions in which the movable weight part 120 is movable are shown by thick arrows). Thereby, the gap (d) of the capacitive part 145 (capacitive devices C1, C2) changes, the capacitance value of the capacitive part 145 (capacitive devices C1, C2) changes, and accordingly, charge transfer occurs. A minute current generated due to the charge transfer is amplified by the amplification circuit contained in the detection circuit part 24, and thereby, the value of acceleration (physical quantity) applied to the movable weight part 120 can be detected. Further, as described above, the direction of acceleration can be detected from the polarities of the two differential signals (+VS1 and −VS1).

### Specific Configuration of Capacitive Device Part

### First Example

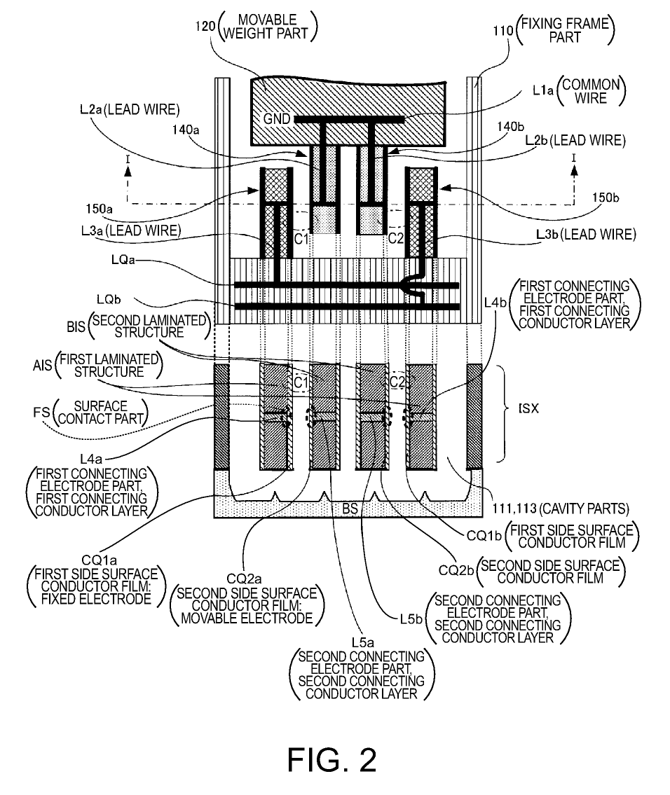

FIG. 2 is a plan view of a main part of the capacitive device part and a sectional view along I-I line. In FIG. 1, the respective two capacitive devices C1, C2 are formed on different sides of the movable weight part 120, however, in practice, as shown in FIG. 2, the respective capacitive devices C1, C2 may be formed by comb-teeth electrodes (electrodes complicated like comb teeth). In reality, to form a capacitive device having a desired capacitance value, several tens to several hundreds of pairs of electrodes (facing sets of the movable electrode and the fixed electrode) are provided.

As seen from the plan view of FIG. 2 (the upper drawing of FIG. 2), in the movable weight part 120, the common wire (GND wire) L1a is formed. Further, to connect the movable electrodes in the movable electrode parts 140a, 140b to the GND, lead wires L2a and L2b are provided. One ends of the respective lead wires L2a and L2b are connected to the common wire (GND wire) L1a. Further, the other ends of the respective lead wires L2a and L2b are connected to second connecting conductor layers L5a, L5b as a second connecting electrode part, respectively.

Further, to take out the detection signals from the fixed electrodes in the fixed electrode parts 150a, 150b, lead wires L3a and L3b are provided. One ends of the respective lead wires L3a and L3b are connected to the detection signal wires (signal output wires) LQa, LQb, respectively. Furthermore, the other ends of the respective lead wires L3a and L3b are connected to first connecting conductor layers L4a, L4b as a first connecting electrode part, respectively.

As seen from the sectional view shown in the lower drawing in FIG. 2, on the substrate BS, a laminated structure ISX (may be referred to as “insulating structure” because it contains plural insulating layers) is formed. As described above, the laminated structure ISX is patterned using RIE (reactive ion etching) or the like, and thereby, the laminated structure ISX is partitioned into the fixing frame part 110, the elastic deforming part 130 (not shown in FIG. 2), the movable electrode parts (140a, 140b: only 140b is shown in FIG. 2), and the fixed electrode parts (150a, 150b: only 150b is shown in FIG. 2).

Around the movable weight part 120, the cavity parts 111 and 113 are formed, and the movable weight part 120 is movably supported along the detection direction by the elastic deforming part 130.

Further, the laminated structures forming the fixed electrode parts (150a, 150b) are referred to as “first laminated structures AIS” for convenience of explanation. Furthermore, the laminated structures forming the movable electrode parts (140a, 140b) are referred to as “second laminated structures BIS” for convenience of explanation.

On the side surfaces (at least on the side surface related to formation of the capacitive device C1 or the capacitive device C2) of the first laminated structure AIS forming the fixed electrode part 150 (150a, 150b), a first side surface conductor film CQ1 (CQ1a, CQ1b) as a fixed electrode is formed. Similarly, on the side surfaces (at least on the side surfaces related to formation of the capacitive device C1 or the capacitive device C2) of the second laminated structure BIS forming the movable electrode part 140 (140a, 140b), a second side surface conductor film CQ2 (CQ2a, CQ2b) as a movable electrode is formed. The fixed electrode CQ1a and the movable electrode CQ2a form the first capacitive device (first variable capacitance capacitor) C1, and the fixed electrode CQ1b and the movable electrode CQ2b form the second capacitive device (second variable capacitance capacitor) C2.

Further, in the first laminated structures AIS, the first connecting conductor layers L4a, L4b that function as the first connecting electrode part are provided. The first connecting conductor layers L4a, L4b may be provided in the first laminated structures AIS or on the first laminated structures AIS, and, in the example of FIG. 2, the first connecting conductor layers L4a, L4b are embedded inside the first laminated structures AIS. In this case, the respective embedded first connecting conductor layers L4a, L4b are protected by the insulating layers forming the first laminated structures AIS.

Further, CVD oxidized films or the like are provided on both the upper sides and the lower sides of the respective first connecting conductor layers L4a, L4b, and thus, the symmetry of the layer structure with respect to the thickness direction is better and the layer structure advantageous in stability to ambient temperature changes can be obtained. That is, even when there is a difference in coefficient of thermal expansion between different material layers, if there is symmetry in the layer structure, the stress is balanced and warpage of wires or the like is suppressed. Accordingly, the circuit characteristics may have advantageous stability to ambient temperature changes.

Similarly, in the second laminated structures BIS forming the movable electrode part 140, the second connecting conductor layers L5a, L5b that function as the second connecting electrode part are provided. The second connecting conductor layers L5a, L5b may be provided in the second laminated structure BIS or on the second laminated structure BIS, and, in the example of FIG. 2, the second connecting conductor layers L5a, L5b are embedded inside the second laminated structure BIS. In this case, the respective embedded second connecting conductor layers L5a, L5b are protected by the insulating layers forming the second laminated structures BIS.

Further, CVD oxidized films or the like are provided on both the upper sides and the lower sides of the respective second connecting conductor layers L5a, L5b, and thus, the symmetry of the layer structure with respect to the thickness direction is better and the layer structure advantageous in stability to ambient temperature changes can be obtained. That is, even when there is a difference in coefficient of thermal expansion between different material layers, if there is symmetry in the layer structure, the stress is balanced and warpage of wires or the like is suppressed. Accordingly, the circuit characteristics may have advantageous stability to ambient temperature changes.

The first connecting conductor layers L4a, L4b as the first connecting electrode part have predetermined patterns (linear patterns in FIG. 2), and may be formed by conductor layers (for example, AL, Cu, or the like) having side surfaces with predetermined areas. The side surfaces of the first connecting conductor layers L4a, L4b are in contact with parts of the first side surface conductor films CQ1a, CQ1b as the fixed electrodes, and thereby, electric connection between the first connecting conductor layers L4a, L4b as the first connecting electrode part and the first side surface conductor films CQ1a, CQ1b as the fixed electrodes may be secured. In FIG. 2, the surface contact parts FS for securement of electric conduction are shown by surrounding dotted lines. Since the first connecting conductor layers L4a, L4b as the first connecting electrode part are electrically connected to the first side surface conductor films CQ1a, CQ1b as the fixed electrodes, bias voltages may be provided via the first connecting conductor layers L4a, L4b as the first connecting electrode part to the first side surface conductor films CQ1a, CQ1b as the fixed electrodes, and, in the case where the fixed electrodes are output electrodes of detection signals (in the example of FIG. 2), the detection signals may be taken out via the first connecting electrode part. The first laminated structures AIS are insulating structures, and accordingly, it is easy to provide the first connecting conductor layers L4a, L4b as the first connecting electrode part.

Similarly, the second connecting conductor layers L5a, L5b as the second connecting electrode part have predetermined patterns (linear patterns in FIG. 2), and may be formed by conductor layers (for example, AL, Cu, or the like) having side surfaces with predetermined areas. The side surfaces of the second connecting conductor layers L5a, L5b are in contact with parts of the second side surface conductor films CQ2a, CQ2b as the movable electrodes, and thereby, electric connection between the second connecting conductor layers L5a, L5b as the second connecting part and the second side surface conductor films CQ2a, CQ2b as the movable electrodes may be secured. In FIG. 2, the surface contact parts FS for securement of electric conduction are shown by surrounding dotted lines. Since the second connecting conductor layers L5a, L5b as the second connecting electrode part are electrically connected to the second side surface conductor films CQ2a, CQ2b as the movable electrodes, bias voltages may be provided via the second connecting conductor layers L5a, L5b as the second connecting electrode part to the second side surface conductor films CQ2a, CQ2b as the movable electrodes (and, in the case where the movable electrodes are output electrodes of detection signals, the detection signals may be taken out via the second connecting electrode part). The second laminated structures BIS are insulating structures, and accordingly, it is easy to provide the second connecting conductor layers L5a, L5b as the second connecting electrode part.

As described above, according to the MEMS structure shown in FIG. 2, the capacitive electrodes (the fixed electrodes and the movable electrodes) of the capacitive devices include conductor films (the first side surface conductor films CQ1a, CQ1b and the second side surface conductor films CQ2a, CQ2b) formed on the side surfaces of the insulating structures (insulating bases). Since the fixed electrodes and the movable electrodes have the insulating structure as bases, inherently, they are electrically insulated. Further, using the insulating structures, it is easy to provide the plural wires electrically independently, and, even when other electrodes of connecting electrodes or the like (electrodes other than the capacitive electrodes) are provided, the electric independence between the respective electrodes may be secured. Therefore, unlike the silicon-based MEMS sensor, a special technique is not necessary for electrically separating the respective different conductors or the manufacturing process does not become complex. Further, for example, since the structure may be manufactured using a general semiconductor manufacturing technology, it is not necessary to use an expensive special substrate such as an SOI substrate and the cost rise may be suppressed. Furthermore, for example, the gaps between the capacitive electrodes (electrode distances) are determined by the patterning accuracy of the insulating layers forming the laminated structures, and, if the current microfabrication technology of semiconductors is used, the gaps between the capacitive electrodes may be made sufficiently narrow. This is effective for higher sensitivity of the sensor and leads to reduction of chip area.

### Example of Manufacturing Method of Capacitive Device

### First Example

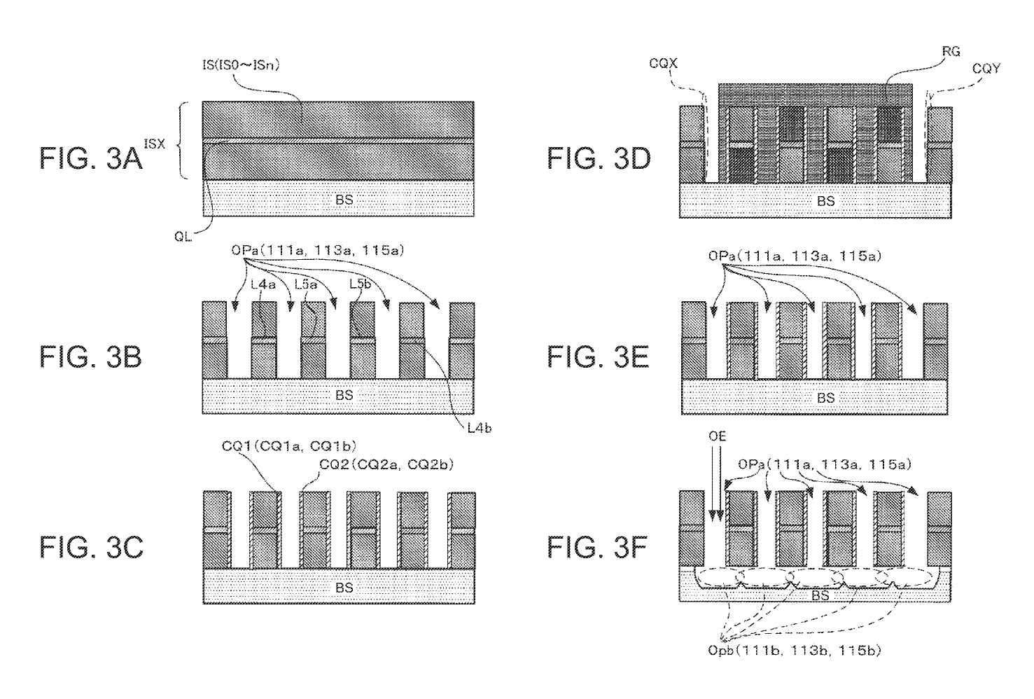

FIGS. 3A to 3F are diagrams (sectional views of a device) for explanation of an outline of a basic manufacturing process (first example) of an MEMS sensor like the capacitive acceleration sensor 100 shown in FIGS. 1 and 2.

At the first step shown in FIG. 3A, the laminated structure ISX in which the insulating layers, at least one conductor layer QL (for example, the conductor layer to be the first connecting conductor layers L4a, L4b as the first connection electrode part, the second connecting conductor layers L5a, L5b as the second connection electrode part, the lead wires L2a, L2b, L3a, L3b, etc.) are formed is formed on the substrate BS.

At the second step shown in FIG. 3B, the laminated structure ISX formed on the substrate BS is patterned by anisotropic etching and a first cavity part Opa (specifically, the first cavity parts 111a, 113a, 115a) is formed. The at least one conductor layer QL is patterned, and thereby, the first connecting conductor layers L4a, L4b as the first connection electrode part and the second connecting conductor layers L5a, L5b as the second connection electrode part are formed. Further, the first cavity part Opa (111a, 113a, 115a) is formed through the laminated structure ISX, and the principal surface of the substrate BS is exposed.

At the third step shown in FIG. 3C, the first side surface conductor film CQ1 (CQ1a, CQ1b) and the second side surface conductor film CQ2 (CQ2a, CQ2b) are formed by sputtering and etching back a metal material such as AL (or using a directional sputtering method), for example.

At the fourth step shown in FIG. 3D, a resist is applied to the entire surface of the substrate BS, then, patterned, and a resist layer RG covering only the capacitive electrode parts is formed, and subsequently, the side surface conductor films (side surface conductor films CQX, CQY in FIG. 3D) in the region not covered by the resist RG are removed by etching.

At the fifth step shown in FIG. 3E, the resist RG is removed. At the sixth step shown in FIG. 3F, an etchant OE for isotropic etching is introduced from the first cavity part Opa (specifically, the first cavity parts 111a, 113a, 115a), the substrate BS underneath is removed by isotropic etching, and a second cavity part Opb (specifically, 111b, 113b, 115b) is formed. The first cavity part Opa (respective 111a, 113a, 115a) and the second cavity part Opb (respective 111b, 113b, 115b) are communicated and the continuous cavity part Op (111, 113, 115) is formed. Thereby, the movable structure is separated from the fixing frame part 110 as the fixing part (releasing step of the movable structure).

Note that, in the manufacturing method of FIGS. 3A to 3F, all of the substrate BS underneath the elastic deforming part 130 and the movable electrode part 140 and the substrate BS underneath the movable weight part 120 are removed, however, if the manufacturing process is changed, the substrate BS may be left only immediately beneath the movable weight part 120 (an application example of the manufacturing method). If the substrate BS remains beneath the movable weight part 120, the mass of the movable weight part increases by the amount of the substrate BS, and the detection sensitivity is improved. The manufacturing method of the application example may contain the following steps, for example.

That is, the rear surface of the substrate BS before the laminated structure ISX is formed is etched and the thickness of the substrate BS is adjusted in advance. Then, as shown in FIG. 3B, the first cavity part Opa (specifically, the first cavity parts 111a, 113a, 115a) is formed in the laminated structure ISX. Then, the etchant is allowed to reach the surface of the substrate BS via the first cavity part Opa (the first cavity parts 111a, 113a, 115a) and the substrate SB is vertically processed and a through hole through the substrate SB is formed. In this state, the movable weight part 120 (including the substrate BS immediately beneath) is separated from the fixing frame part 110 as the fixing part, and the movable weight part 120 has a function of a movable structure of the acceleration sensor.

Note that, in this state, the substrate BS is also left beneath the movable electrode part 140 and the elastic deforming part 130. For example, in the case where adjustment of the dumping factor of the capacitive part and adjustment of the spring constant of the elastic deforming part are necessary, the substrate BS beneath the movable electrode part 140 and the elastic deforming part 130 may be removed by isotropic etching (this provides improvements in the degrees of freedom of the design of the dumping factor of the capacitive part and the design of the spring constant of the elastic deforming part). When the time of the above described isotropic etching is suitably controlled, the substrate BS beneath the elastic deforming part 130 and the movable electrode part 140 in narrow line width is etched from both side surfaces and completely removed, however, the substrate BS may be left beneath the center part of the movable weight part 120 (since the movable weight part 120 has a large area, when the part is isotropically etched from the four side surfaces, only the peripheral parts are removed and the substrate BS in the center part is left). In this manner, the MEMS sensor like the capacitive acceleration sensor 100 shown in FIGS. 1 and 2 may be manufactured.

### Example of Manufacturing Method of Capacitive Device

### Second Example

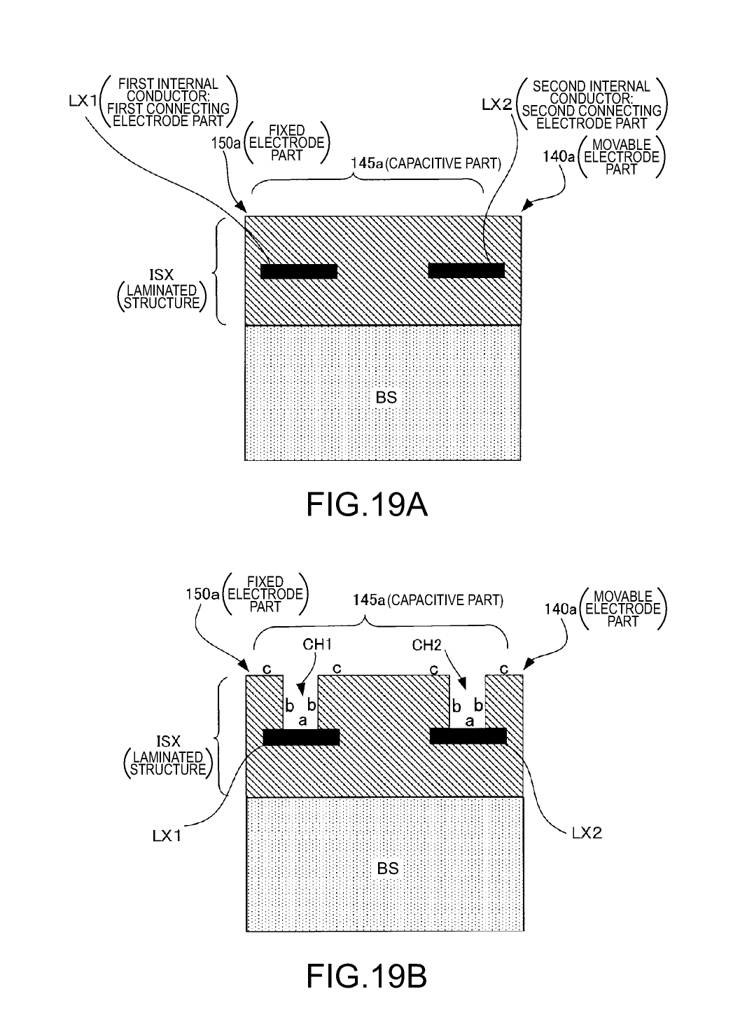

FIGS. 19A to 21C are sectional views of a device with respect to each step for explanation of an outline of a manufacturing method (second example) of the capacitive acceleration sensor 100 shown in FIGS. 1 and 2.

In the manufacturing method of the capacitive acceleration sensor 100 shown in FIGS. 19A to 21C, when the fixed electrode (the first side surface conductor CQ1) is formed in the fixed electrode part 150 and the movable electrode (second side surface conductor CQ2) is formed in the movable electrode part 140, a method of securing electric conduction via contact conductors (connecting conductors) formed to cover the bottom surfaces and the inner wall surfaces of contact holes is employed.

That is, at the first step shown in FIG. 19A, a conductor layer as the first connecting electrode part (first internal conductor: here, referred to as “LX1” for convenience of explanation) is embedded in the laminated structure ISX. The end of the first internal conductor LX1 is not necessary to reach the side surface (the left side surface in the drawing) of the laminated structure ISX. Similarly, a conductor layer as the second connecting electrode part (second internal conductor: here, referred to as “LX2” for convenience of explanation) is embedded in the laminated structure ISX. The end of the second internal conductor LX2 is not necessary to reach the side surface (the right side surface in the drawing) of the laminated structure ISX.

At the second step shown in FIG. 19B, the laminated structure ISX is patterned, and a first contact hole CH1 (may also be referred to as “via hole” or “through hole”) that exposes at least a part of the surface of the embedded first internal conductor LX1 and a second contact hole CH2 (may also be referred to as “via hole” or “through hole”) that exposes at least a part of the surface of the embedded second internal conductor LX2 are formed. The first contact hole CH1 and the second contact hole CH2 may be manufactured at the same time in a common manufacturing process.

In FIG. 19B, parts a are bottom parts (bottom surface parts) of the contact holes, parts b are inner wall surface (inner circumferential surface) parts of the contact holes, and parts care shoulder parts of the laminated structure around the contact holes.

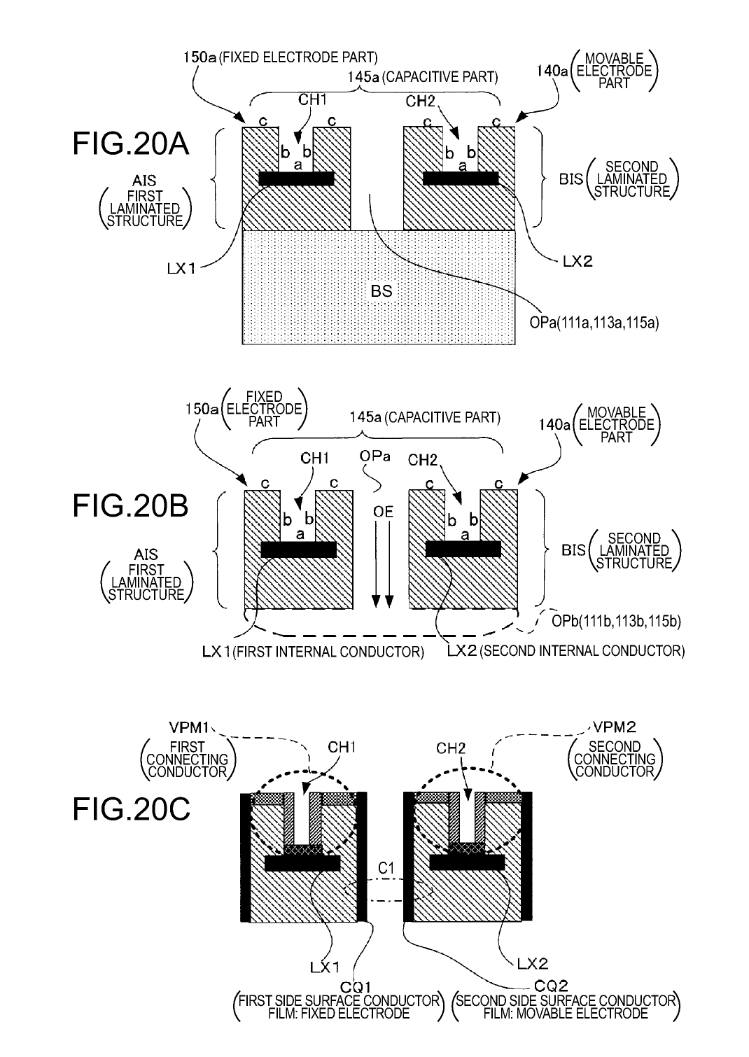

Subsequently, the steps shown in FIGS. 20A to 20C are performed. At the third step shown in FIG. 20A, the first cavity part Opa (111a, 113a, 115a) is formed between the first contact hole CH1 and the second contact hole CH2. Thereby, the common laminated structure ISX is partitioned (sectioned) into the first laminated structure AIS for the fixed electrode part and the second laminated structure BIS for the movable electrode part. In the manufacturing method, at the step of FIG. 19B, the contact holes CH1, CH2 are formed for the common laminated structure ISX before many comb-teeth structures are formed, and thus, there is an advantage that the contact holes are easily formed with high accuracy.

Note that the order of performance of the step of FIG. 19B and the step of FIG. 20A can be reversed. That is, the laminated structure ISX is processed and partitioned into the first laminated structure AIS and the second laminated structure BIS (that is, the comb-teeth structures are formed), and then, in the respective comb-teeth structures (that is, the respective first laminated structure AIS and second laminated structure BIS), the respective contact holes CH1 and CH2 are formed. Using either method, the structure shown in FIG. 20A is obtained. That is, using either method, consequently, a device structure (the structure shown in FIG. 20A) in which the first contact hole CH1 is formed in the first laminated structure AIS and the second contact hole CH2 is formed in the second laminated structure BIS is obtained.

At the fourth step shown in FIG. 20B, an etchant for isotropic etching is allowed to reach the surface of the substrate BS via the first cavity part OPa, and the substrate BS is removed by isotropic etching. Thereby, the movable structure is separated from the fixing frame part 110 as the fixing part (releasing of the movable structure).

At the fifth step shown in FIG. 20C, a contact conductor (first connecting conductor: here, referred to as “VPM1”) covering the bottom surface (that is, on the exposed surface of the first internal conductor LX1) and the inner wall surface of the first contact hole CH1 and joining to the first side surface conductor film (that is, having parts extending to the first side surface conductor film CQ1 in the parts c as shoulder parts) is formed by sputtering, CVD, or the like and, at the same time, the first side surface conductor film CQ1 as the fixed electrode is formed.

In parallel, a contact conductor (second connecting conductor: here, referred to as “VPM2”) covering the bottom surface (that is, on the exposed surface of the second internal conductor LX2) and the inner wall surface of the second contact hole CH2 and joining to the second side surface conductor film CQ2 (that is, having parts extending to the second side surface conductor film CQ2 in the parts c as shoulder parts) is formed by sputtering, CVD, or the like and, at the same time, the second side surface conductor film CQ2 as the movable electrode is formed.

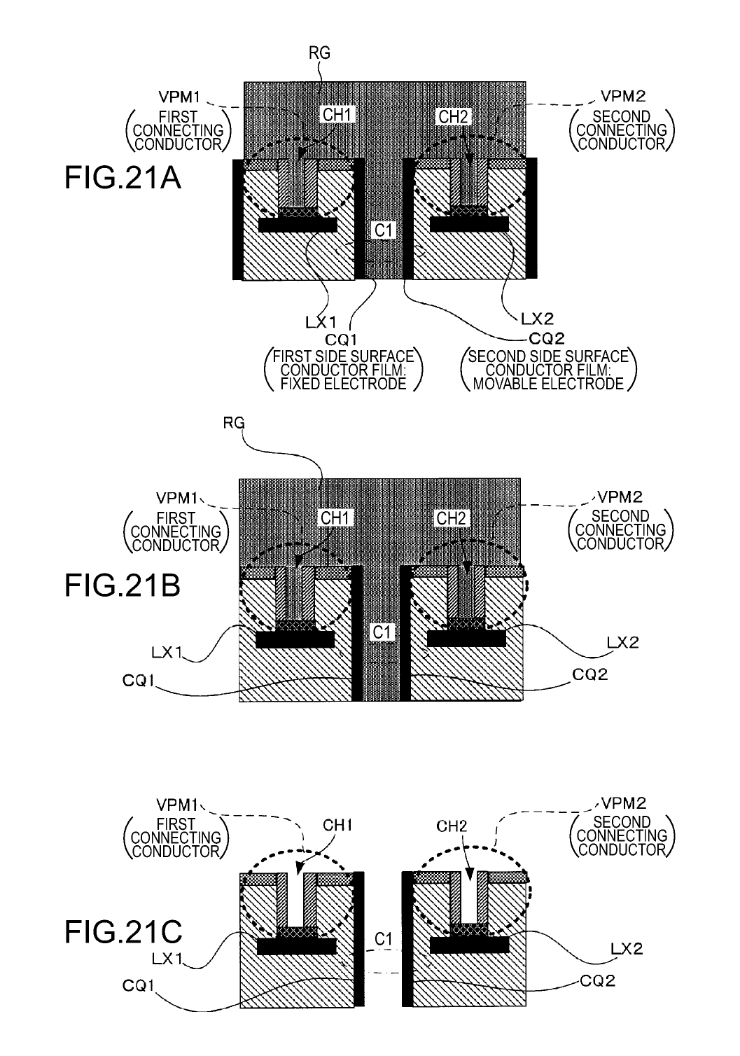

Subsequently, the steps shown in FIGS. 21A to 21C are performed. At the sixth step shown in FIG. 21A, a resist mask RG for removing unnecessary side surface conductor films is formed. At the seventh step shown in FIG. 21B, the unnecessary side surface conductor films (unnecessary side surface metal films) located in the regions not covered by the resist mask RG are removed by etching. In FIG. 21B, for convenience of explanation, the state in which the side surface conductor film on the left end of the device and the side surface conductor film on the right end of the device have been removed is shown. At the eighth step shown in FIG. 21C, the resist mask RG is removed. Thereby, the capacitive acceleration sensor 100 shown in FIGS. 1 and 2 is completed.

By employing the manufacturing method including the respective steps shown in FIGS. 19A to 21C, for example, connection between the respective parts (i.e., the side surface conductor films, the connecting conductors, the internal conductors) may reliably be secured, the contact areas between the conductors may be taken broader, and the margins (margins of locations or the like) at manufacturing may be easily secured, and the proven semiconductor manufacturing process using contact holes etc. may be employed, and thus, an advantage of stability in the manufacturing process can be obtained.

### Regarding Configuration Example of Integrated Circuit Part of Acceleration Sensor

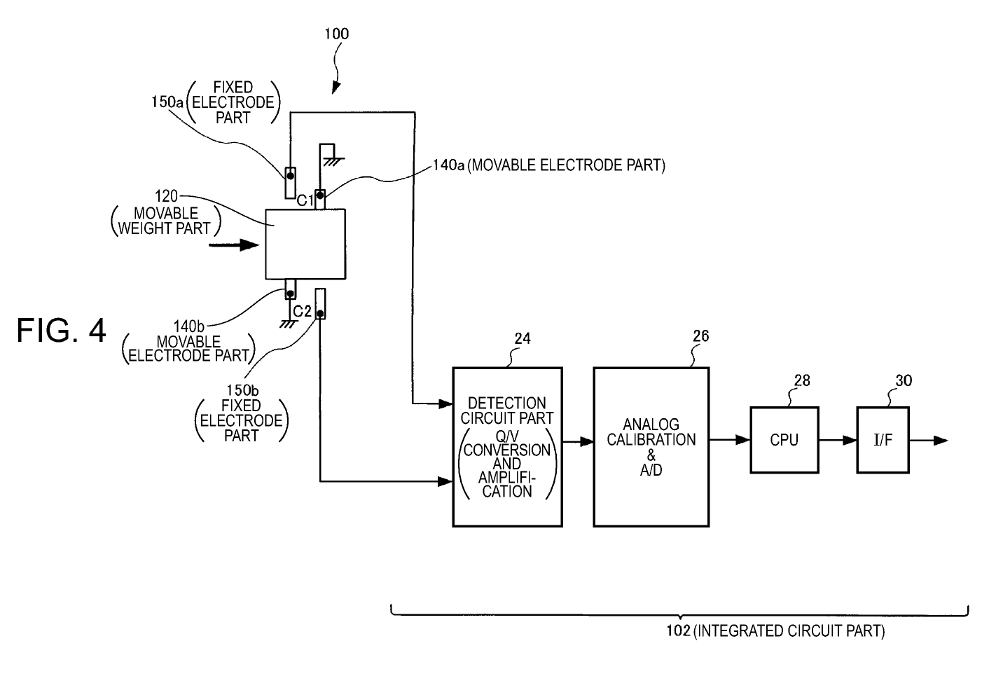

FIG. 4 shows a configuration example of the integrated circuit part (containing the detection circuit part) of the capacitive acceleration sensor. The capacitive acceleration sensor 100 has at least two pairs of movable and fixed electrodes. In FIG. 4, the sensor has the first movable electrode part 140a and the second movable electrode part 140b, and the first fixed electrode part 150a and the second fixed electrode part 150b. The first movable electrode part 140a and the first fixed electrode part 150a form the first capacitive device (first variable capacitance capacitor) C1. The second movable electrode part 140b and the second fixed electrode part 150b form the second capacitive device (second variable capacitance capacitor) C2. The potentials of one electrodes (here, the movable electrodes) in the respective first and second capacitive devices C1, C2 are fixed to the reference potential (for example, the ground potential). The potentials of the fixed electrode parts may be connected to the reference potential (for example, the ground potential).

The detection circuit part 24 contained in the integrated circuit part 102 is formed by the CMOS process, for example. The detection circuit part 24 may include an amplification circuit SA, an analog calibration and A/D conversion circuit unit 26, a central processing unit (CPU) 28, and an interface (I/F) circuit 30. Note that the configuration is an example, but not limited to the configuration. For example, the CPU 28 may be replaced by a control logic, and the A/D conversion circuit may be provided at the output stage of the amplification circuit provided in the detection circuit part 24. The analog/digital conversion circuit, the central processing unit may be provided in another integrated circuit in some cases.

When acceleration is acted on the stationary movable weight part 120, a force by the acceleration is acted on the movable weight part 120 and the respective gaps between the pairs of movable and fixed electrodes change. If the movable weight part 120 moves in the direction of an arrow in FIG. 4, the gap between the first movable electrode part 140a and the first fixed electrode part 150a becomes larger and the gap between the second movable electrode part 140b and the second fixed electrode part 150b becomes smaller. Since the gap and the capacitance have an inverse relation, the capacitance value C1 of the first capacitive device C1 formed by the first movable electrode part 140a and the first fixed electrode part 150a becomes smaller and the capacitance value C2 of the second capacitive device C2 formed by the second movable electrode part 140b and the second fixed electrode part 150b becomes larger.

Charge transfer occurs according to the changes of the capacitance values of the first and second capacitive devices C1, C2. The detection circuit part 24 has a charge amplifier (Q/V conversion circuit) using a switched capacitor, for example, and the charge amplifier converts a minute current signal (charge signal) generated due to the charge transfer into a voltage signal by a sampling operation and a integration (amplification) operation. The voltage signal output from the charge amplifier (i.e., an acceleration detection signal detected by the acceleration sensor) is calibrated (for example, adjustment of phase and signal amplitude or the like, and additionally, low-pass filter processing may be performed thereon) by the analog calibration and A/D conversion circuit unit 26, and then, converted from the analog signal to a digital signal.

Here, using FIGS. 5A to 5C, an example of a configuration and an operation of the Q/V conversion circuit will be explained. FIG. 5A shows a basic configuration of the Q/V conversion amplifier (charge amplifier) using a switched capacitor, and FIG. 5B shows voltage waveforms of the respective parts of the Q/V conversion amplifier shown in FIG. 5A.

As shown in FIG. 5A, the basic Q/V conversion circuit has a first switch SW1 and a second switch SW2 (forming the switched capacitor of the input part with the variable capacity C1 (or C2)), an operation amplifier (OPA) 1, a feedback capacity (integration capacity) Cc, a third switch SW3 for resetting the feedback capacity Cc, a fourth switch SW4 for sampling the output voltage Vc of the operation amplifier (OPA) 1, and a holding capacity Ch.

As shown in FIG. 5B, the first switch SW1 and the third switch SW3 are on/off-controlled by a first clock in the same phase, and the second switch SW2 is on/off-controlled by a second clock in the opposite phase to that of the first clock. The fourth switch SW4 is turned on in a short period at the end of the period in which the second switch SW2 is on. When the first switch SW1 is turned on, a predetermined voltage Vd is applied to the ends of the variable capacity C1 (or C2), and charge is accumulated in the variable capacity C1 (or C2). Concurrently, the feedback capacity Cc is in the reset state (both ends are shorted) because the third switch SW3 is on. Then, the first switch SW1 and the third switch SW3 are turned off and the second switch SW2 is turned on, the ends of the variable capacity C1 (or C2) are at the ground potential, and the charge accumulated in the variable capacity C1 (or C2) transfers toward the operation amplifier (OPA) 1. In this regard, the amount of charge is conserved, Vd·C1 (C2)=Vc·Cc holds, and accordingly, the output voltage Vc of the operation amplifier (OPA) 1 is (C1/Cc)·Vd. That is, the gain of the charge amplifier is determined by the ratio between the capacitance value of the variable capacity C1 (or C2) and the capacitance value of the feedback capacity Cc. Then, when the fourth switch (sampling switch) SW4 is turned on, the output voltage Vc of the operation amplifier (OPA) 1 is held by the holding capacity Ch. The held voltage is Vo, and the Vo is the output voltage of the charge amplifier.

As shown in FIG. 4, to the practical detection circuit part 24, differential signals from the respective two capacitors, i.e., the first capacitive device C1 and the second capacitive devices C2 are input. In this case, as the charge amplifier, for example, a charge amplifier having a differential configuration as shown in FIG. 5C may be used. In the charge amplifier shown in FIG. 5C, at the input stage, a first switched capacitor amplifier (SWla, SW2a, OPAla, Cca, SW3a) for amplification of the signal from the variable capacity C1 and a second switched capacitor amplifier (SW1b, SW2b, OPA1b, Ccb, SW3b) for amplification of the signal from the variable capacity C2 are provided. Further, the respective output signals (differential signals) of the operation amplifiers (OPA) 1a and 1b are input to a differential amplifier (OPA2, resistances R1 to R4) provided at the output stage. As a result, the amplified output signal Vo is output from the operation amplifier (OPA) 2. Using the differential amplifier, an advantage that the base noise (common-mode noise) can be removed is obtained.

Note that the above explained configuration example of the charge amplifier is an example, and not limited to the configuration. Further, in FIGS. 4 and 5A to 5C, for convenience of explanation, only the two pairs of movable and fixed electrodes are shown, however, not limited to the form, but the number of pairs of electrodes may be increased according to the necessary capacitance values. In practice, for example, several tens to several hundreds of pairs of electrodes are provided. Furthermore, in the above example, in the two capacitors, i.e., the first capacitive device C1 and the second capacitive devices C2, the gaps between the electrodes change and the capacities of the respective capacitors (first and second capacitive devices C1, C2) change, however, not limited to that, but a configuration in which the opposed areas of the respective two movable electrodes relative to one reference electrode change and the capacities of the two capacitors (first and second capacitive devices C1, C2) change may be employed (this configuration is effective for detection of the acceleration acting in the Z-axis direction (the direction perpendicular to the substrate)).

### Second Embodiment

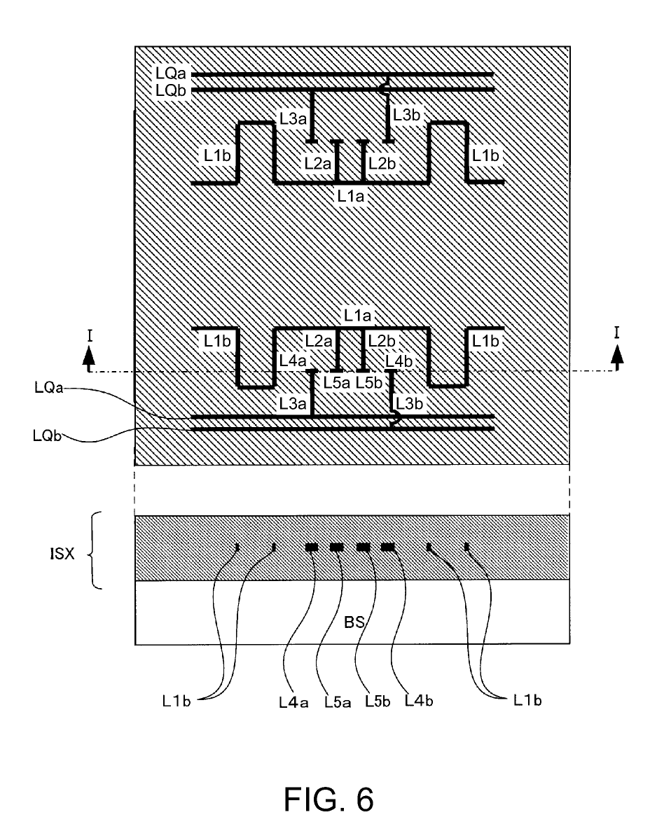

In the embodiment, an example of a manufacturing method of a capacitive MEMS acceleration sensor will be described. As below, the manufacturing method of an acceleration sensor module shown in FIG. 1 will be explained with reference to FIGS. 6 to 12. In the manufacturing method shown in FIGS. 6 to 12, the method that has been explained using FIGS. 3A to 3E is employed (this is an example, and the method shown in FIGS. 19A and 19B may be employed).

### First Step

FIG. 6 shows a planar shape and a sectional structure of a device in a state in which a laminated structure is formed on a substrate (first step). The upper drawing of FIG. 6 is a plan view and the lower drawing of FIG. 6 is a sectional view along I-I line in the plan view.

At step 1, the laminated structure containing at least one conductor layer and plural insulating layers (basically insulating structure: insulating structure) is formed. Note that the rear surface of the semiconductor substrate (here, a silicon substrate) BS may selectively be etched for adjustment of the thickness of the silicon substrate BS in advance.

Specifically, on the silicon substrate BS, a laminated structure ISX is formed using a semiconductor manufacturing method. The laminated structure ISX may contain stacked plural hierarchically different insulating layers, for example. The laminated structure ISX may contain an insulating layer as a surface protective film covering the surface of the silicon substrate BS, n (n is an integer number equal to or more than “1”) interlayer insulating films, an insulating film as a final protective film, etc., for example, and further, at least one conductor material layer (for example, may be multilayer wiring containing n metal layers). The respective insulating layers may be formed by depositing materials of NSG, BPSG, SOG, TEOS, or the like in thickness of 10000 to 20000 angstroms by CVD.

As shown in FIG. 6, in the process of forming the laminated structure ISX, at least one conductor layer is patterned, and the respective wires and the respective electrodes described above using FIGS. 1 and 2 are formed. That is, the common wires (ground wires) L1a, L1b, the lead wires L2a, L2b and L3a, L3b, the detection signal wires (signal output wires) LQa, LQb, the first connecting conductor layers L4a, L4b as the first connecting electrode part, and the second connecting conductor layers L5a, L5b as the second connecting electrode part are formed.

### Second Step

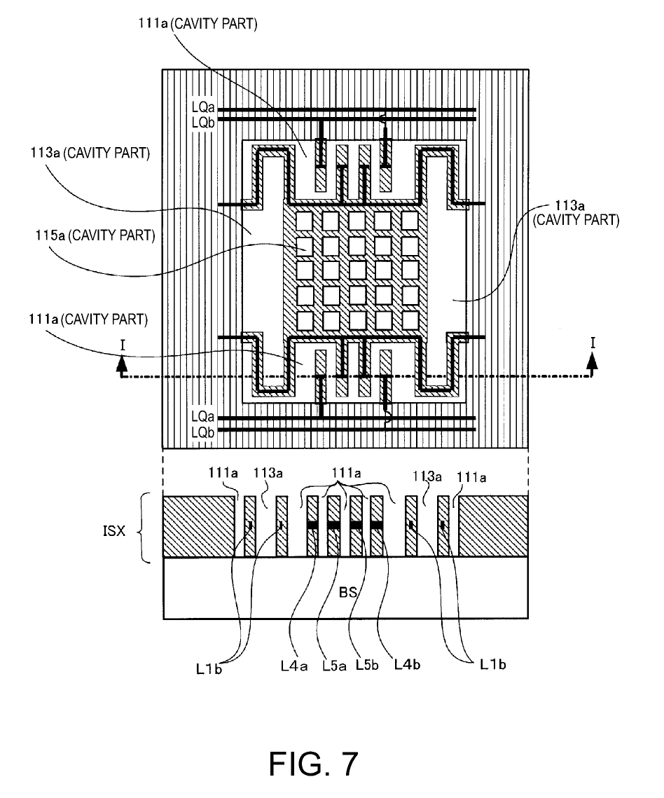

FIG. 7 shows a planar shape and a sectional structure of the device in a state in which the laminated structure on the substrate is patterned (second step). The upper drawing of FIG. 7 is a plan view and the lower drawing of FIG. 7 is a sectional view along I-I line in the plan view.

At the second step, the first cavity parts (first opening parts) 111a, 113a (and 115a) penetrating the laminated structure ISX are formed. The first cavity parts (first opening parts) 111a are opening parts formed around the movable electrode part 140 and the fixed electrode part 150. The first opening parts 113a are opening parts formed around the side on which the movable electrode part 140 is not provided of the four sides forming the movable weight part 120 (seen in planer view). For convenience of explanation, the first cavity part (first opening part) is divided into two of the cavity part 111a, the cavity part 113a according to the location where it is formed, however, these are cavity parts (opening parts) formed at the same time, and they can be considered as one cavity part (111a or 113a).

The first cavity parts (first opening part: 111a, 113a) are formed by selectively patterning the laminated structure ISX by anisotropic etching. The etching step is anisotropic etching of an insulating film at a high aspect ratio of a ratio (H/D) of the etching depth H (for example, 4 to 6 μm) to the opening diameter D (for example, 1 μm), for example. As an etchant for the anisotropic etching, for example, a mixed gas of CF₄, CHF₃, or the like may be used. By the etching, the laminated structure may be partitioned into the fixing frame part 110 as the fixing part, the movable weight part 120, and the elastic deforming part 130. The silicon substrate BS beneath is not processed, and the respective parts are connected to the fixing frame part 110 by the silicon substrate BS.

### Third Step

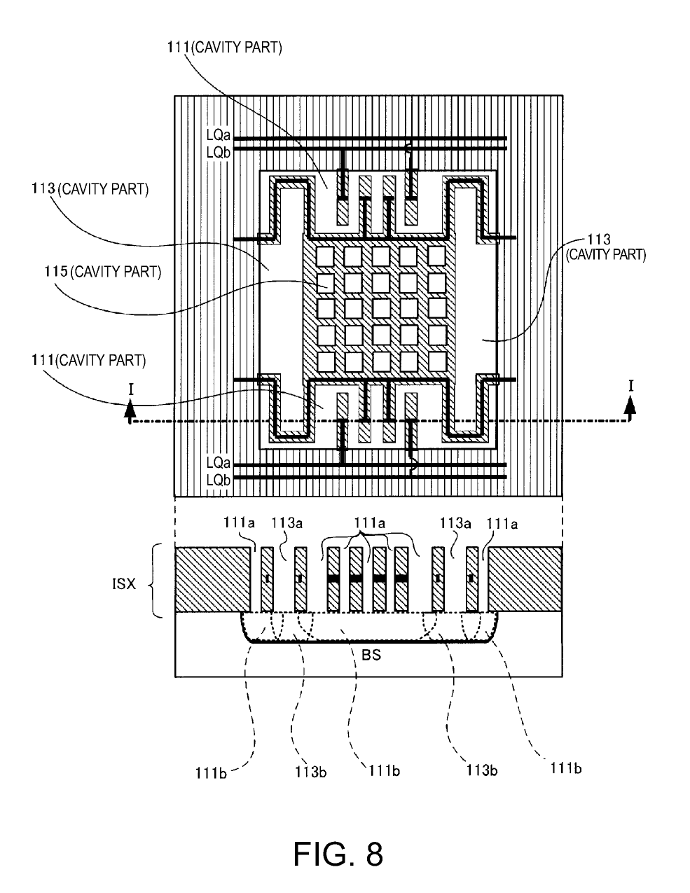

FIG. 8 shows a planar shape and a sectional structure of the device in a state in which the substrate is etched and the movable weight part and the movable electrode part are separated from the fixing frame part as the fixing part (third step). The upper drawing of FIG. 8 is a plan view and the lower drawing of FIG. 8 is a sectional view along I-I line in the plan view.

At the third step, an etchant for isotropic etching is introduced via the first cavity parts (first opening parts) 111a, 113a (and 115a) formed in the laminated structure ISX, and the silicon substrate BS is isotropically etched. By the isotropic etching, a part of the silicon substrate BS is removed and the second cavity parts (second opening parts) 111b, 113b (and 115b) are formed. The first cavity parts (first opening parts) 111a and the second cavity parts (second opening parts) 111b are communicated, and thereby, the cavity part 111 is formed around the movable weight part 120. Similarly, the first cavity parts (first opening parts) 113a and the second cavity parts (second opening parts) 113b are communicated, and thereby, the cavity part 113 is formed around the movable weight part 120. Further, the first cavity parts (first opening parts) 115a and the second cavity parts (second opening parts) 115b are communicated, and thereby, the silicon substrate BS beneath the movable weight part 120 is removed and the cavity part 115 is formed around the movable weight part 120.

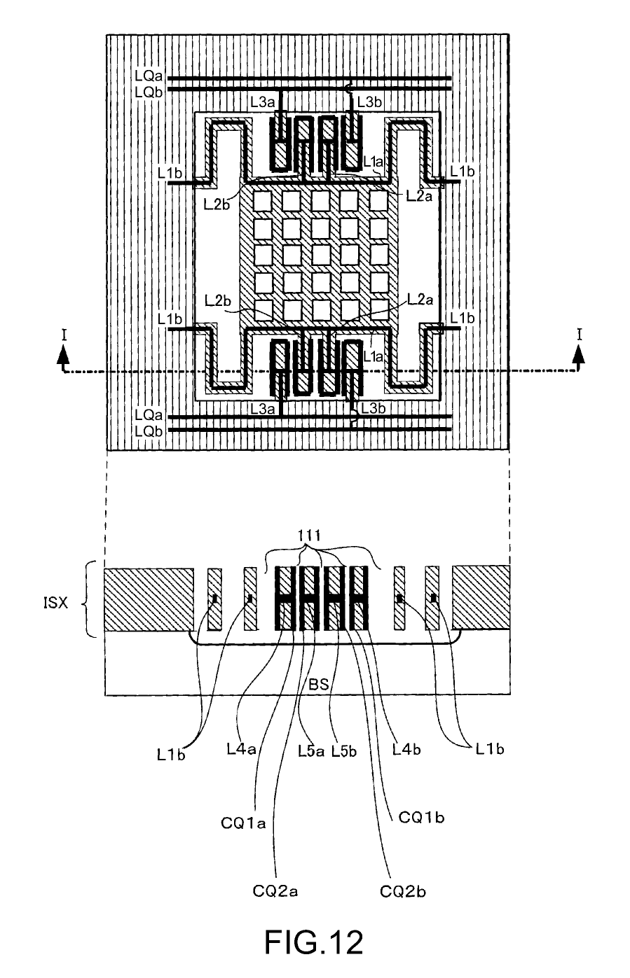

The etching of the silicon substrate BS may be performed after the capacitive electrodes are formed (that is, the step of FIG. 12 is completed).

### Fourth Step

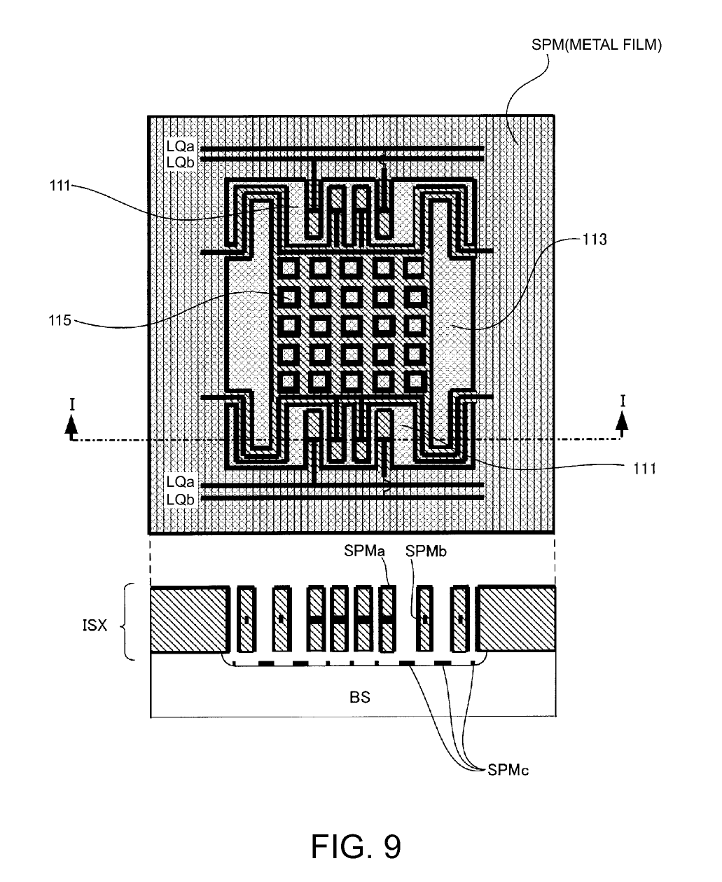

FIG. 9 shows a planar shape and a sectional structure of the device in a state in which a metal material is deposited on the entire surface of the device (fourth step). The upper drawing of FIG. 9 is a plan view and the lower drawing of FIG. 9 is a sectional view along I-I line in the plan view.

As shown in the plan view of FIG. 9, a metal film (for example, an AL film) SPM is formed on the entire surface of the device by sputtering or CVD (here, sputtering is used). As a result, as shown in the sectional view of FIG. 9, metal materials SPMa are deposited in the parts as comb-teeth electrodes on the laminated structures, metal materials SMPb are formed on the side surfaces of the laminated structures, and further, metal materials SPMc are partially deposited on the bottom surfaces of the etched and removed parts of the silicon substrate BS (may be referred to as cavity parts within the silicon substrate BS).

### Fifth Step

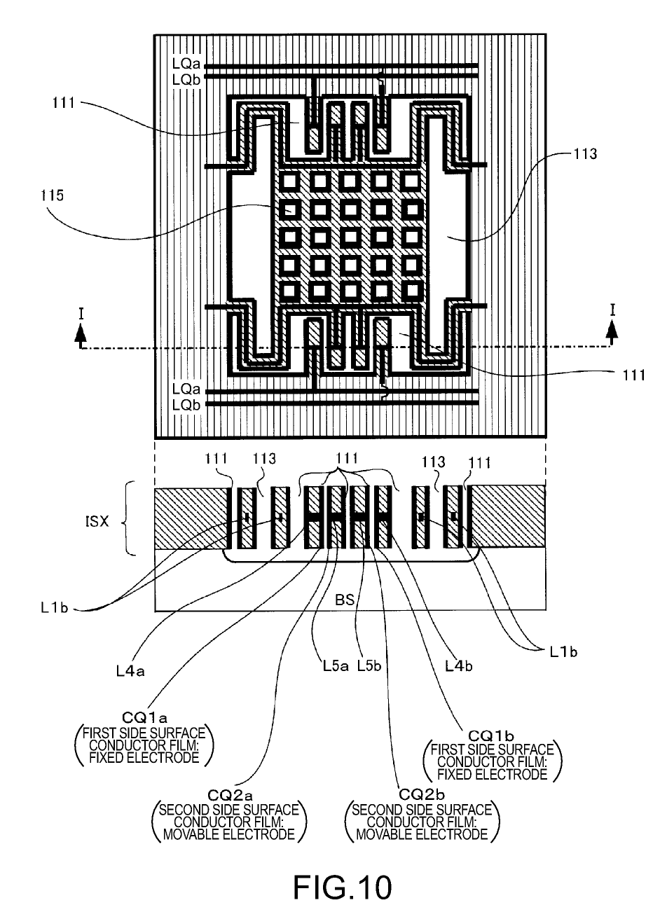

FIG. 10 shows a planar shape and a sectional structure of the device in a state in which the metal material formed on the entire surface of the device is etched back (fifth step). The upper drawing of FIG. 10 is a plan view and the lower drawing of FIG. 10 is a sectional view along I-I line in the plan view.

As shown in the plan view of FIG. 10, for example, anisotropic dry etching is executed on the entire surface of the device (etch back processing). Thereby, the metal materials SPMa deposited on the laminated structures are removed, and, at the same time, the metal materials SPMc deposited on the bottom surfaces of the etched and removed parts of the silicon substrate BS (the cavity parts within the silicon substrate BS) are also removed. As a result, on the side surfaces of the laminated structures, the first side surface conductor CQ1 (CQ1a, CQ1b) as one capacitive electrodes (i.e., fixed electrodes) and the second side surface conductor CQ2 (CQ2a, CQ2b) as the other capacitive electrodes (i.e., movable electrodes) are formed.

### Sixth Step

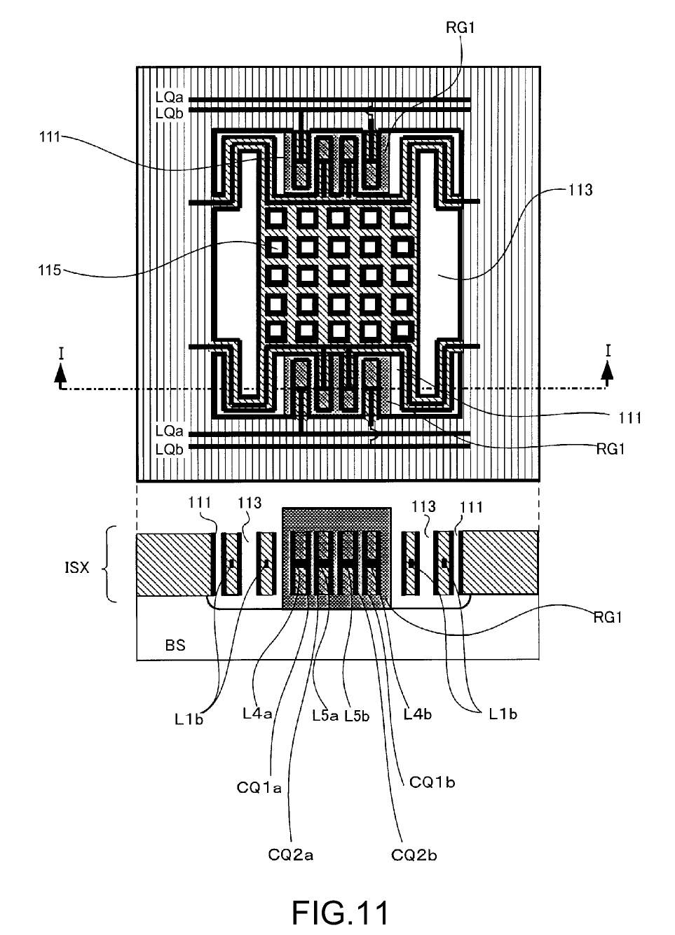

FIG. 11 shows a planar shape and a sectional structure of the device in a state in which an etching mask (resist) is selectively formed in the capacitive parts (comb-teeth parts) (sixth step). The upper drawing of FIG. 11 is a plan view and the lower drawing of FIG. 11 is a sectional view along I-I line in the plan view.

At the sixth step, as shown in FIG. 11, in the capacitive parts (comb-teeth parts), a resist RG1 as an etching mask is selectively formed.

### Seventh Step

FIG. 12 shows a planar shape and a sectional structure of the device in a state in which etching is entirely performed using the resist as the etching mask and then the resist is removed (seventh step). The upper drawing of FIG. 12 is a plan view and the lower drawing of FIG. 12 is a sectional view along I-I line in the plan view.

At the seventh step, as shown in FIG. 12, etching (for example, anisotropic etching such as RIE) is executed on the entire surface of the device using the resist RG1 as the etching mask, and the metal materials deposited in the parts other than the capacitive parts (comb-teeth parts) are removed. As a result, the MEMS sensor like the capacitive acceleration sensor 100 shown in FIGS. 1 and 2 is completed.

### Third Embodiment

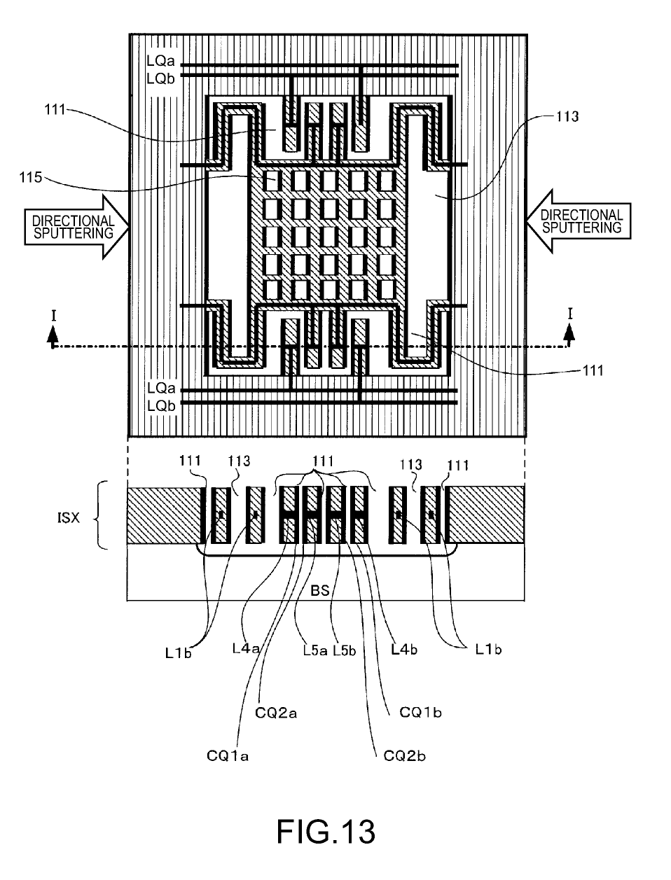

FIG. 13 is a plan view and a sectional view of a device for explanation of a manufacturing method using directional sputtering for formation of capacitive electrodes. The upper drawing of FIG. 13 is a plan view and the lower drawing of FIG. 13 is a sectional view along I-I line in the plan view.

As shown in FIG. 13, in the embodiment, when the first side surface conductor CQ1 (CQ1a, CQ1b) as the fixed electrode and the second side surface conductor CQ2 (CQ2a, CQ2b) as the movable electrode are formed, directional sputtering (may be referred to as directive sputtering) is used. The directional sputtering (directive sputtering) is a technology of aligning the directions of metal atoms flying out from the target by sputtering and forming metal layers and metal films by the aligned metal atoms, for example.

As the directional sputtering (directive sputtering), an ionization PVD (Physical Vapor Deposition) method or a low-pressure long-throw sputtering method may be used. Using the directional sputtering (directive sputtering), the first side surface conductor film CQ1 (CQ1a, CQ1b) and the second side surface conductor film CQ2 (CQ2a, CQ2b) may respectively be deposited directly (that is, without etch back) on the side surface of the first laminated structure AIS and the side surface of the second laminated structure BIS.

The ionization PVD can be used for deposition (formation of barrier metal or the like) having good coverage for the via holes at the high aspect ratio, for example, and has advantages that a deposition rate to some degree may be secured, film quality may be improved, deposition with less damage may be performed, and the like. The high directionality of the ionization PVD may be realized, for example, when the metal atoms sputtered from the target are ionized in plasma and their metal ions are accelerated within the sheath of the substrate surface and perpendicularly enter the substrate (here, the substrate BS on which the first laminated structure AIS and the second laminated structure BIS are formed). To realize the high directionality, it is effective to generate a strong local magnetic field only immediately above the target.

Further, the long-throw sputtering is a sputtering method of suppressing the influence of a reflection angle and the influence of collision with background atoms for improvement of directionality. Ion beam sputtering typically generates plasma of rare gas such as argon (Ar) or xenon (Xe), allows the plasma to collide with the target metal electrode, and deposit the flicked out atoms on the substrate placed on the opposite side. Since the sputtered atoms are isotropically scattered, if the distance between the target electrode and the substrate is small, the sputtered atoms are affected by the scattering angle and they enter the substrate at various angles. In order to prevent this, the distance between the target electrode and the substrate BS is purposely extended and the pressure is lowered, and thereby, the influence of the reflection angle and the influence of collision with background atoms can be prevented. The sputtering having directionality using the technique is the long-throw sputtering (LTS), and the step coverage is remarkably improved using the long-throw sputtering.

Therefore, the first side surface conductor film CQ1 (CQ1a, CQ1b) and the second side surface conductor film CQ2 (CQ2a, CQ2b) may stably be deposited on the side surfaces (for example, perpendicular surfaces) of the first laminated structure AIS and the second laminated structure BIS. Note that the above example is an example, but another directional (directive) sputtering method may be used.

When the metal films are deposited by the directional (directive) sputtering, deposition is performed not only on the side surfaces of the laminated structures but also on the upper surfaces of the laminated structures. Thus, the metal films on the upper surfaces are removed by anisotropic dry etching such as RIE. Further, for example, the metal films existing on the upper surfaces of the laminated structures may be removed by executing metal sputtering or the like under the condition that the resist at insulating film etching (the resist used at the step of FIG. 11) remains, and then, removing the resist (metal film removal by lift-off using the resist). Further, when the directional (directive) sputtering is performed, thin metals are deposited on the side surfaces in the direction along the flow of metal atoms of the side surfaces of the laminated structures. Thus formed thin metal films are unnecessary metal films that do not function as capacitive electrodes (electrodes of capacitors). The unnecessary metal films may be removed by isotropic etching in a short period, for example.

### Fourth Embodiment

In the manufacturing method of the embodiment, patterning of the laminated structure on the substrate is performed in twice. The outline is as follows. That is, at the first patterning, the regions where the capacitive devices are formed (i.e., capacitive device formation regions including regions where opposed electrodes are formed) are selectively opened. Then, conductor films covering the inner wall surfaces of the opening parts are formed. For the formation of the conductor films, a method of a combination of sputtering and etch back, the directional (directive) sputtering method or the like may be used. The conductor films will be the first side surface conductor film as the fixed electrode and the second side surface conductor film as the movable electrode later, however, under the condition, the films are deposited on all of the inner wall surfaces (inner circumferential surfaces) of the opening parts, and contain unnecessary parts that do not function as capacitive electrodes.

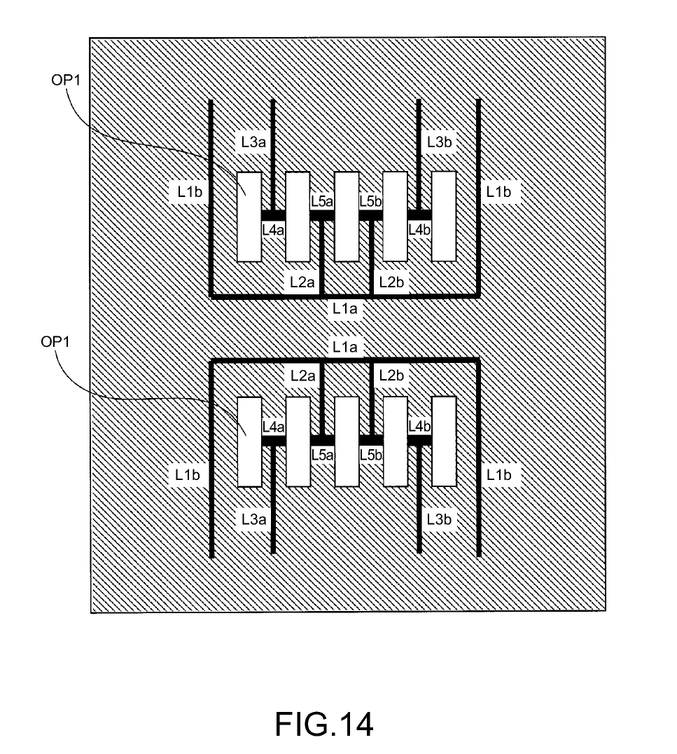

Accordingly, then, the second patterning is executed, and thereby, the structure is partitioned into the fixing frame part as the fixing part, the elastic deforming part, the movable weight part, the fixed electrode part, and the movable electrode part. At the same time, the unnecessary conductor film parts that do not function as capacitive electrodes are removed, and the first side surface conductor film as the fixed electrode and the second side surface conductor film as the movable electrode are formed. For example, then, the etchant for isotropic etching is allowed to reach the substrate via the opening parts and the substrate is isotropically etched, and thereby, the movable weight part and the movable electrode part are separated from the fixing frame part (fixing part). The method of the embodiment is effective as a variation (modified example) of the manufacturing process, for example. As below, the method will specifically be explained with reference to FIGS. 14 to 18.

### First Step

FIG. 14 is a plan view of the device after the first patterning of the laminated structure. As described above, on the laminated structure, the common wires (ground wires) L1a, L1b, the lead wires L2a, L2b and L3a, L3b, the detection signal wires (signal output wires) LQa, LQb, the first connecting conductor layers L4a, L4b as the first connecting electrode part, and the second connecting conductor layers L5a, L5b as the second connecting electrode part are formed.

At the first step shown in FIG. 14, opening parts (opening parts penetrating the laminated structure) OP1 are selectively formed by the first insulating layer dry etching. To the inner wall surfaces (inner circumferential surfaces) of the laminated structure provided with the first opening parts OP1, the ends of the first connecting conductor layers L4a, L4b as the first connecting electrode part reach and, as a result, their side surfaces are exposed, and similarly, the ends of the second connecting conductor layers L5a, L5b as the second connecting electrode part reach and, as a result, their side surfaces are exposed.

### Second Step

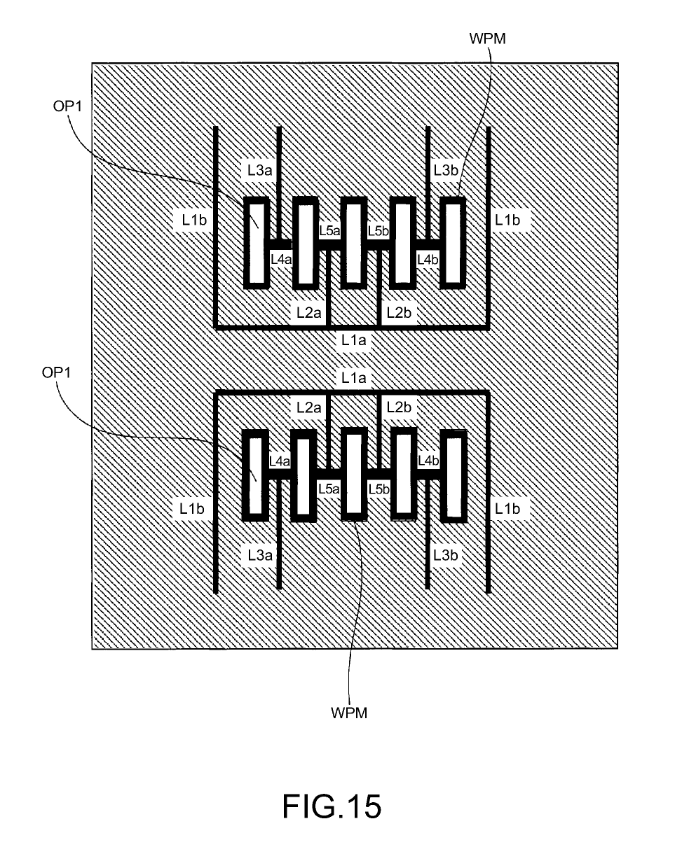

FIG. 15 is a plan view of the device showing a state in which metals are deposited on the inner wall surfaces of the laminated structure in which the opening parts have been formed.

At the second step shown in FIG. 15, metal films (conductor films) are deposited on the entire surface of the device by sputtering or CVD, and etched back by anisotropic dry etching such as RIE. As a result, only the metal films (conductor films) on the inner wall surfaces of the laminated structure on which the opening parts OP1 have been formed are left. The metal films (conductor films) are in contact with the first connecting conductor layers L4a, L4b as the first connecting electrode part and the second connecting conductor layers L5a, L5b as the second connecting electrode part (that is, electric conduction is secured). Note that the metal films (conductor films) may be deposited using the directional (directive) sputtering.

### Third Step

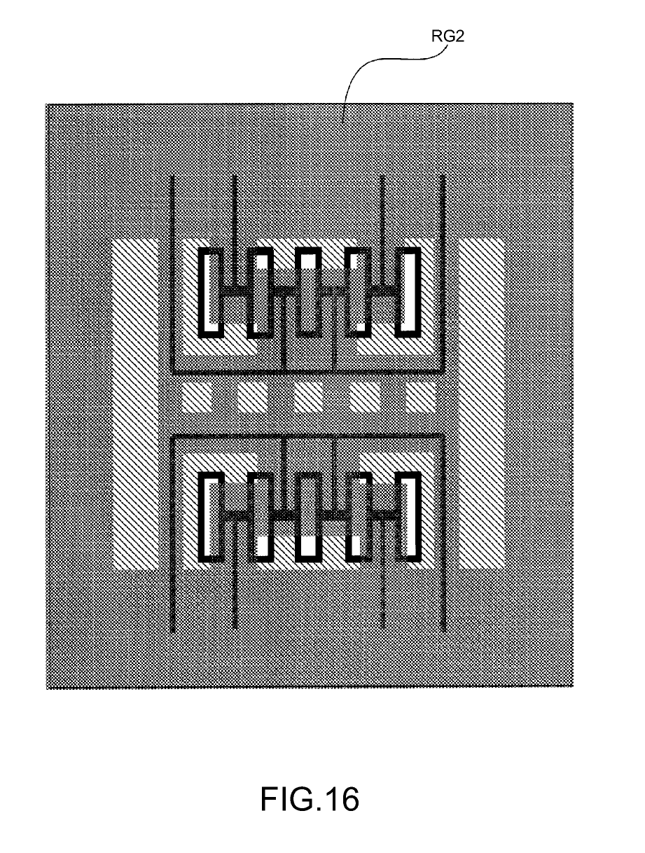

FIG. 16 is a plan view of the device showing a state in which a resist is patterned. At the third step shown in FIG. 16, a resist pattern RG2 is applied to the entire surface of the device, and then, patterning is performed by photolithography.

### Fourth Step

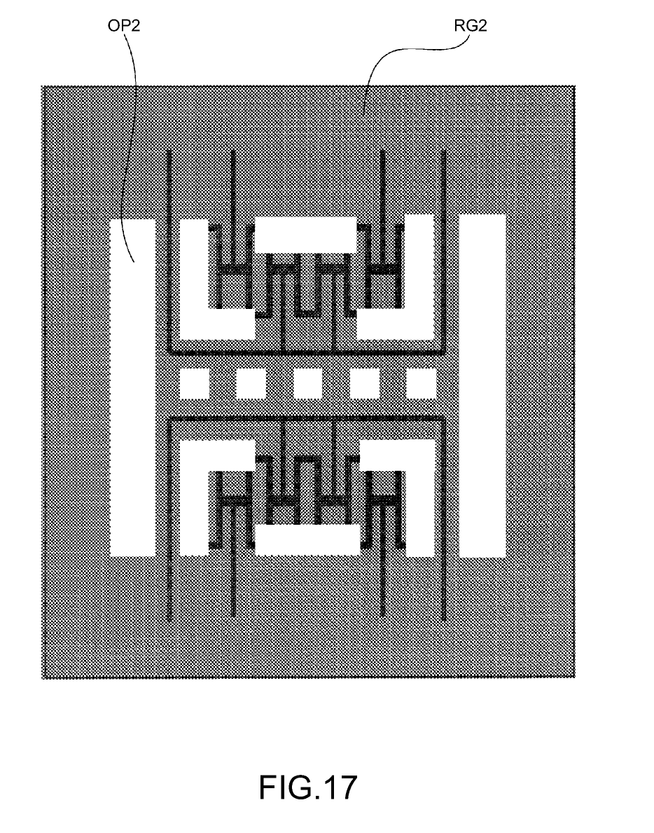

FIG. 17 is a plan view of the device showing a state in which the insulating films and the side surface metal films forming the laminated structure are etched using the resist pattern as an etching mask.

At the fourth step shown in FIG. 17, the insulating films (multilayered insulating layers) and the side surface metal films forming the laminated structure are etched using the resist pattern as the etching mask, and opening parts OP2 penetrating the laminated structure are formed. For the etching of the insulating films (laminated insulating films), for example, anisotropic dry etching such as RIE may be used. Further, the etching of the side surface metal films may be performed before or after the etching of the insulating layers, and anisotropic dry etching such as RIE may be used therefor. Then, isotropic etching of the substrate is performed and the structure is released.

### Fifth Step

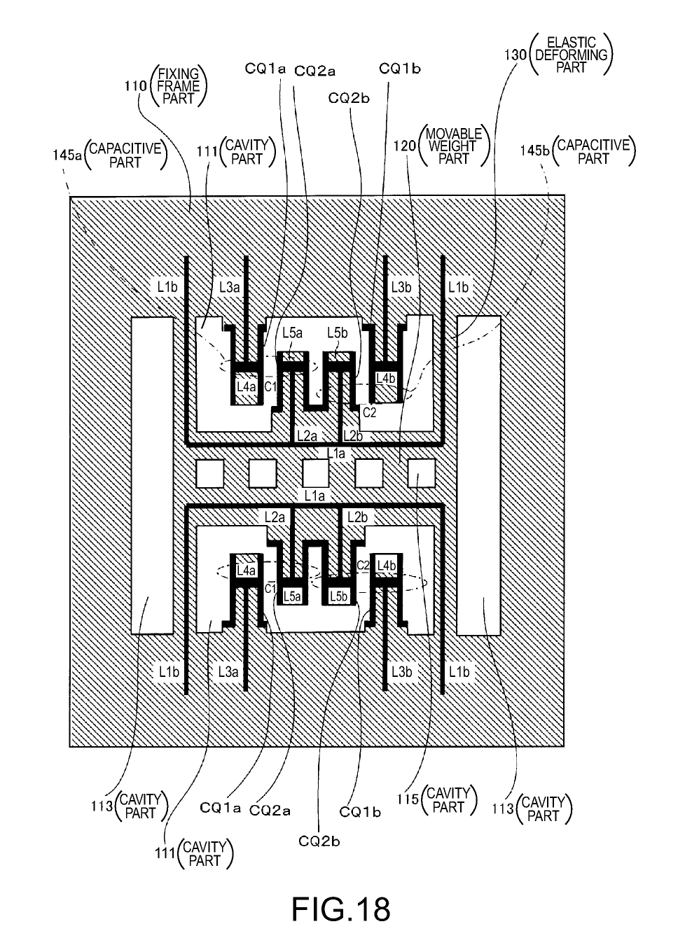

FIG. 18 is a plan view showing a state in which the resist pattern as the etching mask is removed. By removing the resist pattern RG2 as the etching mask, the capacitive MEMS sensor (here, a capacitive acceleration sensor) is completed. In FIG. 18, the same signs are assigned to the parts common with the above described drawings.

In at least one embodiment that has been explained, the insulator-based structure is used, and thus, it is not necessary to provide a complicated step of forming an insulating trench and a capacitive MEMS sensor (here, a capacitive acceleration sensor) may be manufactured with the smaller number of steps. Further, using a typical semiconductor manufacturing device, a capacitive MEMS sensor may be manufactured on a typical substrate (for example, silicon substrate).

Further, for example, the gap between capacitive electrodes (electrode distance) is determined by the patterning accuracy of the insulating layers forming the laminated structure, and the gap between capacitive electrodes can sufficiently be made narrow using the current microfabrication technology of semiconductors. This is effective for higher sensitivity of the sensor and leads to reduction of chip area.

Furthermore, in the case where the first connecting conductor layers L4a, L4b and the second connecting conductor layers L5a, L5b are embedded within the insulating laminated structure, CVD oxide films or the like are provided on both the upper sides and the lower sides of the respective conductor layers, and thus, symmetry of the layer structure with respect to the thickness direction is better and the layer structure advantageous in stability to ambient temperature changes can be obtained. That is, even when there is a difference in coefficient of thermal expansion between different material layers, if there is symmetry in the layer structure, the stress is balanced and warpage of wires or the like is suppressed. Accordingly, the circuit characteristics may have advantageous stability to ambient temperature changes.

### Electronic Apparatus

In an electronic apparatus including a physical quantity sensor such as the capacitive acceleration sensor 100 of the embodiments, downsizing, higher performance, or lower cost can be realized.

As a electronic apparatus including a physical quantity sensor, for example, there are a global positioning system widely known as GPS, a portable information terminal such as PDA (Personal Digital Assistant), or a small electronic apparatus such as a cellular phone or a mobile computer having their functions. In the small electronic apparatus, demand for smaller and thinner equipment is getting higher and enhancement of functions and lower cost are desired at the same time. As a physical quantity sensor included in the electronic apparatus, using the physical quantity sensor manufactured by the manufacturing method of the embodiments such as the capacitive acceleration sensor 100 at lower cost, with higher accuracy, or in smaller size, a small electronic apparatus whose cost is reduced and functionality is advanced may be provided.

As above, some embodiments have been explained, however, a person skilled in the art would easily understand that many modifications may be made without substantially departing from the new matter and effects of the invention. Therefore, such modifications may be included within the scope of the invention. For example, in the specifications and drawings, terms described with different terms in the broader or synonymous sense at least once may be replaced by the different terms in any part of the specifications and drawings.

For example, the physical quantity sensor (MEMS sensor) according to the invention is not necessarily limited to one that is applied to the capacitive acceleration sensor, but may be applied to a piezoresistive acceleration sensor. Further, it may be applied to a physical quantity sensor that detects capacitive changes by the movement of the movable weight part. For example, it may be applied to a gyro sensor, a silicon diaphragm pressure sensor, or the like. For example, it may be applied to a pressure sensor that deforms the silicon diaphragm by the air pressure of the cavity (hollow chamber) and detects capacitive changes by the deformation (or changes of the resistance value of the piezoresistance).

Further, by providing one pair of opposed electrodes having a variable gap (distance between electrodes), at least the magnitude of the physical quantity may be detected. Note that, using one capacitive device, the direction in which the physical quantity acts may not be detected. Accordingly, it is preferable to provide two capacitive devices having opposite directions in which gaps change. From the respective two capacitive devices, signals having the same absolute value and different polarities (i.e., differential signals) are obtained, and thus, the direction in which the physical quantity (acceleration or the like) acts may be known by determining the respective polarities of the differential signals. Further, the detection axes of the physical quantity are not limited to uniaxial or biaxial as described above, however, multiaxial of three or more may be employed. Furthermore, a method of detecting a physical quantity using changes of opposed areas between electrodes of a capacitor may be employed.

The entire disclosure of Japanese Patent Application No. 2009-205598, filed Sep. 7, 2009 is expressly incorporated by reference herein.

What is claimed is:

1. A physical quantity sensor comprising:
a fixing part;
an elastic deforming part;
a movable weight part coupled to the fixing part via the elastic deforming part;
a fixed arm part extended from the fixing part; and
a movable arm part extended from the movable weight part and provided to face the fixed arm part via a gap,
wherein the fixed arm part and the movable arm part are laminated structures containing insulating layers and conductor layers,
the fixed arm part has a first side surface conductor film provided on a side surface of the fixed arm part and a first connecting electrode part using the conductor layer and electrically connected to the first side surface conductor film, and
the movable arm part has a second side surface conductor film provided on a side surface opposed to the first side surface conductor film and a second connecting electrode part using the conductor layer and electrically connected to the second side surface conductor film.

2. The physical quantity sensor according to claim 1, wherein the first connecting electrode part and the second connecting electrode part are provided within the insulating layers.

3. The physical quantity sensor according to claim 2, wherein a contact hole is provided in the fixed arm part or the movable arm part, and
the first connecting electrode part and the first side surface conductor film or the second connecting electrode part and the second side surface conductor film are connected via the contact hole.

4. The physical quantity sensor according to claim 1, wherein an integrated circuit part is provided in the fixing part, and
the first connecting electrode part and the second connecting electrode part are connected to the integrated circuit part.

5. The physical quantity sensor according to claim 1, wherein one of the first connecting electrode part and the second connecting electrode part is grounded.

6. An electronic apparatus comprising the physical quantity sensor according to claim 1.

7. A manufacturing method of a physical quantity sensor, comprising:
forming a laminated structure using an insulating layer and a conductor layer on a substrate;
etching the laminated structure to form a fixing part, a movable weight part, an elastic deforming part that couples the fixing part and the movable weight part, a fixed arm part extending from the fixing part, and a movable arm part extending from the movable weight part;
forming a first side surface conductor film on a side surface of the fixed arm part and a second side surface conductor film on a side surface of the movable arm part;
connecting a first connecting electrode part formed using the conductor layer of the fixed arm part and the first side surface conductor film, and connecting a second connecting electrode part formed using the conductor layer of the movable arm part and the second side surface conductor film; and
etching the substrate to form gaps between the respective movable weight part, movable arm part, elastic deforming part and the substrate.

8. The manufacturing method of a physical quantity sensor according to claim 7, wherein the first side surface conductor film and the second side surface conductor film are formed by ionization PVD or long-throw sputtering.

9. The manufacturing method of a physical quantity sensor according to claim 7, further comprising:
forming the first connecting electrode part and the second connecting electrode part within the insulating layer, and forming a contact hole to expose at least a part of surfaces of the first connecting electrode part and the second connecting electrode part; and
forming electrodes on an inner wall surface of the contact hole, a surface of the fixed arm part, and a surface of the movable arm part, and connecting the first connecting electrode part and the first side surface conductor film and connecting the second connecting electrode part and the second side surface conductor film.
